(19) United States
(12) Patent Application Publication
(10) Pub. No.: US 2026/0196114 A1
(43) Pub. Date: Jul. 9, 2026

(54) INTRUDER DETECTION SYSTEM AND METHOD

(71) Applicant: Essence Security International (E.S.I.) Ltd., Herzlia Pituach (IL)

(72) Inventors: Ohad AMIR, Herzlia (IL); Jonathan Mark SCHNAPP, Tel Aviv (IL)

(21) Appl. No.: 19/440,414

(22) Filed: Jan. 5, 2026

(30) Foreign Application Priority Data
Jan. 6, 2025 (GB) 2500104.1

(51) Int. Cl. G08B 13/181

(52) U.S. Cl. CPC G08B 13/181

(57) ABSTRACT

Monitoring a region to detect an intruder may comprise, in an embodiment, receiving a first set of Ranging Active Reflective Wave Detector (RARWD) measurements; obtaining a reference entrance-behaviour based on the first set of RARWD measurements, the reference entrance-behaviour defining a normal human transit behaviour through at least part of a region; receiving a second set of RARWD measurements to monitor for an intruder; determining from the second set of RARWD measurements a current entrance-behaviour of a person; determining whether the current entrance-behaviour of the person has a requisite correlation with the reference entrance-behaviour to determine whether a normal entrance-behaviour condition is satisfied; and controlling output indicative of whether the normal entrance-behaviour condition is determined to be satisfied. The second set of RARWD measurement may be used to track the spatial location of the person to determine the current entrance-behaviour of the person.

### CROSS-REFERENCE TO RELATED APPLICATIONS

The present application claims priority to United Kingdom Application No.

2500104.1 filed with the Intellectual Property Office of the United Kingdom on Jan. 6, 2025, which is incorporated herein by reference in its entirety for all purposes.

### TECHNICAL FIELD

The present invention relates generally to a method, computer-readable storage medium and device and system for monitoring a region to detect an intruder.

### BACKGROUND

Intrusion detection systems are configured to identify intruders at premises. Such systems employ various different techniques to identify intruders and to discriminate between intruders and legitimate occupants. Many systems are configured such that legitimate occupants that enter a vacant premises trigger the system into a state that will cause an alarm unless the legitimate occupant performs a disarming action within an entry delay period. The state is commonly entered by the system detecting a presence or movement of a person at the premises. The disarming action could involve, for example, entering a pin number into a keypad or disarming the system on a mobile phone associated with authorised users and/or providing a password and username, or the like.

Different systems may be configured to perform different actions in response to identifying a trigger condition for which a disarming action is not performed within the entry delay period. For example, some systems may directly raise an audible alarm, take one or more verification actions (e.g. capturing one or more images), deploy deterrent measures, and/or notify a nominated recipient, such as a user or monitoring station, and/or the like.

In intruder detection system, false intruder detections are undesirable and may lead to undesirable outcomes such as false alarms, a waste of system resources in checking intrusion detections, unwanted power drain and the like. Furthermore, reducing the manual burden on users is preferable. As such, improved accuracy in the detection of intruders and/or discrimination between intruders and legitimate occupants can be of significant importance.

### SUMMARY

Various aspects of the present invention are defined in the independent claims. Some preferred features are defined in the dependent claims.

According to a first aspect of the present disclosure is a computer-implemented method for monitoring a region to detect an intruder, the method comprising:
receiving a first set of Ranging Active Reflective Wave Detector (RARWD) measurements for tracking human position in multiple spatial dimensions within a region observed by at least one RARWD;
obtaining at least one reference entrance-behaviour based on the first set of RARWD measurements, the at least one reference entrance-behaviour defining at least one normal human transit behaviour through at least part of the region following a detected triggering-event associated with entry into the region, the at least one normal human transit behaviour comprising a characteristic defined in multiple spatial dimensions;
after receiving the first set of RARWD measurements, receiving a second set of RARWD measurements to monitor for an intruder into the region;
determining from the second set of RARWD measurements a current entrance-behaviour of at least one person following a detected triggering-event associated with entry into the region, the current entrance-behaviour being determined with respect to multiple spatial dimensions;
determining whether the current entrance-behaviour of the at least one person has a requisite correlation with the at least one reference entrance-behaviour to determine whether a normal entrance-behaviour condition is satisfied; and
responsive to the determining of whether the normal entrance-behaviour condition is satisfied, controlling output indicative of whether the normal entrance-behaviour condition is determined to be satisfied.

The at least one reference entrance-behaviour may be a learned at least one reference entrance-behaviour that is learned based on the first set of RARWD measurements. The method may comprise learning the at least one reference entrance-behaviour based on the first set of RARWD measurements. The learning may be performed on a device that collects the first set of RARWD measurements or on a different device, which may be a local or remote device to the device that collects the first set of RARWD measurements. In a particular embodiment, the obtaining of at least one reference entrance-behaviour may comprise, on a device that comprises a RARWD that collects the first set of RARWD measurements, learning the at least one reference entrance-behaviour. The different device may be different to, and may be local to or remote from, at least one of: a device that determines the current entrance-behaviour; and/or a device that determines whether the current entrance-behaviour of the at least one person has the requisite correlation with the at least one reference entrance-behaviour. Local may comprise being in the same premises and/or configured to communicate via a local area network and/or via a short range wired or wireless communications such as Wi-Fi, Bluetooth, ZigBee or the like. Remote may comprise being in a different premises and/or may comprise being configured to communicate over the internet, cellular telecommunications network and/or a wide area network. The obtaining of the at least one reference entrance-behaviour may comprise transmitting the first set of RARWD measurements or data derived therefrom or indicative thereof, to the different device that performs the learning based on the first set of RARWD measurements, and receiving the at least one reference entrance-behaviour from the different device that performs the learning based on the first set of RARWD measurements.

The controlling of the output may comprise either generating or not generating the output, depending on whether the normal entrance-behaviour condition is determined to be satisfied or is determined not to be satisfied. The controlling of the output may comprise identifying or varying the output, e.g. identifying or varying the content or form of the output responsive to the determining of whether the normal entrance-behaviour condition is satisfied.

The controlling of the output responsive to the determining of whether the normal entrance-behaviour condition is satisfied may comprise generating the output when the normal entrance-behaviour condition is determined not to be satisfied, wherein the output may be indicative of the normal entrance-behaviour condition being determined not to be satisfied. The output may comprise an indication that the normal entrance-behaviour condition has been determined not to be satisfied or the generation of the output in itself may be indicative of the normal entrance-behaviour condition having been determined not to be satisfied.

The controlling of the output responsive to the determining of whether the normal entrance-behaviour condition is satisfied may comprise generating the output when the normal entrance-behaviour condition is determined to be satisfied, wherein the output may be indicative of the normal entrance-behaviour condition being determined to be satisfied.

The controlling of the output may comprise not generating the output.

The controlling of the output responsive to the determining of whether the normal entrance-behaviour condition is satisfied may comprise not generating the output, wherein the lack of an output may, in itself, be indicative of the normal entrance-behaviour condition being determined not to be satisfied. The output may comprise an indication that the normal entrance-behaviour condition has been determined to be satisfied or the generation of the output in itself may be indicative of the normal entrance-behaviour condition having been determined to be satisfied.

The controlling of the output responsive to the determining of whether the normal entrance-behaviour condition is satisfied may comprise not generating the output, wherein the lack of an output may, in itself, be indicative of the normal entrance-behaviour condition being determined to be satisfied.

In embodiments where the controlling of the output responsive to the determining of whether the normal entrance-behaviour condition is satisfied comprises not generating the output, another device of a security system may receive a first notification of a person entering or approaching the region, and expect a second notification from a RARWD of the at least one RARWD depending on whether the normal entrance-behaviour condition is satisfied. For example, the other device may conclude that, if no second notification is received within a predetermined time after receiving the first notification, the normal entrance-behaviour condition was determined not to be satisfied. Optionally a RARWD of the at least one RARWD may generate the first notification in response, which may be the same RARWD of the at least one RARWD that generates the first notification. Alternatively, another device (e.g. a PIR motion sensor or a door sensor) may generate the first notification.

Optionally, the output may indicate the requisite correlation that the current entrance-behaviour does or does not have with the at least one reference entrance-behaviour.

The method may be performed by an intruder detection system, such as an intruder alarm system, or a system with intruder alarm functionality. The method may comprise raising an alarm dependent at least in part on the output being indicative of the normal entrance-behaviour condition having been determined not to be satisfied. The alarm may be raised by a device that comprises the at least one RARWD and/or the output may be transmitted directly or indirectly to at least one remote device to raise the alarm based on the output. In some examples, the method is implemented while the alarm system is not in an armed state. Optionally the alarm system may operate without arming states. The at least one reference entrance-behaviour does not include a time taken to disarm an alarm system. The at least one reference entrance-behaviour may not involve disarming an alarm system.

The first set of RARWD measurements may optionally comprise a plurality of subsets of RARWD measurements. Each subset of RARWD measurements may correspond to, or be for, a different period of time. That is, the first set of RARWD measurements may be collected during a single session or operation of the RARWD or may be collected over multiple different sessions or operations of the RARWD.

The method may comprise tracking a spatial location (e.g. as defined by multi-dimensional (two or preferably three dimensional) coordinates) of the at least one person, e.g. to determine the current entrance-behaviour of the least one person. The method may comprise using the second set of RARWD measurement to track the spatial location (e.g. as defined by multi-dimensional (two or preferably three dimensional) coordinates) of the at least one person to determine the current entrance-behaviour of the least one person.

The method may comprise tracking a plurality of people simultaneously to derive respective current entrance-behaviours of different people. The tracking a plurality of people may comprise tracking spatial locations (e.g. coordinates) of the plurality of people, based on the second set of RARWD measurements. The determining whether a normal entrance-behaviour condition is satisfied may comprise determining whether the current entrance-behaviour of at least one or any of a or the plurality of different people has a requisite correlation with the at least one reference entrance-behaviour.

Optionally the detected triggering-event that is followed by the current entrance-behaviour and the detected triggering-event that is followed by the at least one normal human transit behaviour may be required to be sensed by: a same sensing device or any sensing device of a same set of sensing devices. The same sensing device and/or the same set of sensing devices may optionally be set up to sense entry into the region from one particular location only. The at least one reference entrance-behaviour may be learned during a defined learning period, such as but not limited to a set-up period or a learning period selected by a user or installer or the like.

The at least one RARWD may be configured to capture the second set of RAWD measurements only once the learning period has completed.

Each of the at least one normal human transit behaviours may optionally represent any human transit behaviour that is detected as occurring during the defined learning period. In other words, whatever the system observes during the learning period, the system may treat as being within the scope of normal, so “normal”, as used herein, may be any reference that the security systems learns, or is trained or instructed, to treat as normal. Thus, the term “normal” in the phrase “normal human transit behaviour” should not be taken as requiring any particular frequency of regularity of occurring. In the examples herein, the current entrance-behaviour of the at least one person may be taken to mean the current entrance-behaviour of all of the at least one persons.

In some examples, determining from the second set of RARWD measurements whether the current entrance-behaviour of at least one person has a requisite correlation with the at least one reference entrance-behaviour may comprise determining whether the current entrance-behaviour of each person has a requisite correlation with any reference entrance-behaviour of the least one reference entrance-behaviours.

In other words, every present person, whether that be one person or a plurality of people, must behave with a requisite correlation with a reference entrance-behaviour in order for the normal entrance-behaviour condition to be satisfied. In cases where there are multiple reference entrance-behaviours, the requisite correlation may optionally be with any reference entrance-behaviour. Optionally different people of the plurality of people having a requisite correlation with different reference entrance-behaviours of the plurality of reference entrance-behaviours satisfies the normal entrance-behaviour condition.

In other examples, determining from the second set of RARWD measurements whether the current entrance-behaviour of at least one person has a requisite correlation with the at least one reference entrance-behaviour comprises determining whether the current entrance-behaviour of each person has a requisite correlation with a particular reference entrance-behaviour of the least one reference entrance-behaviours.

In some examples, satisfying the normal entrance-behaviour condition requires all of the plurality of people to have a requisite correlation with a same reference entrance-behaviour of the at least one reference entrance-behaviours. Thus, the at least one reference entrance-behaviour may consist of an essential reference entrance-behaviour in common for any and all of the at least one person.

The at least one person may be a predefined number of persons. In other embodiments, the at least one person may be any number of persons up to and including a predefined maximum number of persons. Optionally, the at least one person is every one of one or more people represented in the second set of RARWD measurements.

In examples, the at least one person may be a subset of a plurality of people represented in the second set of RARWD measurements. For example, provided the subset of the plurality of people has a requisite correlation with the at least one reference entrance-behaviour, then having one or more people, not part of the subset, that do not have a requisite correlation with the at least one reference entrance-behaviour may not derogate from the normal entrance-behaviour being satisfied. In some examples, the subset may number one person, which in some examples may be any one person from the plurality of people. As long as one person has a current entrance-behaviour having a requisite correlation with the at least one reference entrance-behaviour, other people may not have to have a current entrance-behaviour having a correlation with a reference entrance-behaviour. As used herein the term “each” in reference to “at least one” of an item means “the” in cases where the at least one item is more specifically one item.

The at least one reference entrance-behaviour may be defined in relation to one or more instances of a triggering event associated with entry into the region. Each of the at least one normal human transit behaviours may represent a human transit behaviour being performed one or more times, each of the one or more times following respective one or more instances of a triggering event associated with entry into the region.

In embodiments where a normal human transit behaviour represents a human transit behaviour being performed more than one time, the reference entrance-behaviour may correspond to a representative average or other combination or function of the more than one times.

Optionally, multiple instances of performing a similar human transit behaviour may be grouped together, and the representative average may be based on the multiple instances in a group.

The method may comprise identifying multiple instances of performing a similar human transit behaviour, e.g. based on a clustering algorithm. Optionally the method may comprise distinguishing between different human transit behaviours, e.g. based on the clustering algorithm.

Optionally the current entrance-behaviour may be determined with reference to a later instance of the triggering event, later instance being after said one or more instances of the triggering event.

Optionally, the at least one reference entrance-behaviour may further define at least one duration of time associated with performance of the at least one normal human transit behaviour. For example, the performance of a given normal human transit behaviour, or of a part of the normal human transit behaviour, may last a given duration of time.

Each of the at least one reference entrance-behaviours may comprise or consist of one or more aspects of behaviour. For example, the one or more aspects of behaviour may comprise one or more of:
arriving at a first milestone location associated with a first milestone event;
arriving at second milestone location associated with a second milestone event;
traversing at least part of the region according to a travel-path; and/or
traversing at least part of the region through a pathway.

The term “travel-path” and/or the term “pathway” as used in the context of being comprised in the one or more aspects of behaviour may alternatively be referred to “normal travel-path” and “normal-pathway” respectively.

The second milestone location may be different to the first milestone location. Optionally arriving at the second milestone location may be associated with a second time milestone time and arriving at the first milestone location may be associated with a first milestone time. The at least one duration of time may thus comprise the first milestone time, as a first duration of time, and the second milestone time, as a second duration of time. The second milestone time may be different to the first milestone time. This may be the case if the first milestone event occurs at a different time to the second milestone event. For example, the second milestone event may relate to a later instance of stopping walking compared to the first milestone event. However, in other examples, the second milestone time may be the same as the first milestone time. This may occur, for example, if the feature(s) defining the second milestone event are not dependent on the feature(s) defining the first milestone event.

The one or more aspects of behaviour may comprise arriving at any, some or all of a plurality of milestone locations, e.g. there may optionally be further milestone locations in addition to the first and second milestone locations. In other examples, there may only be a single milestone location, i.e. the first milestone location. Optionally, the one or more aspects of behaviour may comprise arriving at a sequence of milestone locations, the sequence of milestone locations comprising a plurality of milestone locations associated with respective milestone events, e.g. different milestone events. However, the milestone locations need not be in a sequence. For example, the first and second milestone locations need not be sequential or otherwise part of a sequence, in some examples they may be independent of each other, and optionally also of further milestone locations.

The milestone locations, e.g. the first milestone location and/or the second milestone location, may be defined in multiple spatial dimensions (e.g. with reference to 3D coordinates).

The method may comprise analysing the first set of RARWD measurements to identify at least one of the milestone events, e.g. the first milestone event and/or the second milestone event, based on a detected object performing one or more predefined milestone features of the respective milestone event, e.g. of the first and/or second milestone event.

The milestone events, e.g. the first milestone event and/or the second milestone event, may optionally comprise any one or more of the following milestone features:
human travel of a predefined distance since being at a defined previous location, e.g. a location of entering the region;
human travel of a predefined displacement from a defined previous location, e.g. a location of entering the region;
a predefined amount of time having passed since a human entered the region or since a triggering event;
changing speed of movement in a predetermined manner by a human, after commencing a transit through at least part of the region; and
changing direction of movement in a predetermined manner by a human after commencing a transit through at least part of the region.

For the second milestone event and/or milestone events in the sequence of milestone events after a first milestone event in the sequence of milestone events, the defined previous location may optionally be the first milestone location or a milestone location of a preceding milestone event in the sequence of milestone events.

The changing speed of movement in a predetermined manner may comprise stopping or pausing.

In some examples, the one or more milestone features of the milestone events, e.g. the first and/or second milestone event, may comprise a changing speed of movement in a predetermined manner by a human, after commencing a transit through at least part of the region. The predetermined manner may be changing speed from a non-zero speed to being stationary. The non-zero speed may be a predefined minimum walking speed or within a predefined walking speed range.

In some embodiments, the one or more aspects of behaviour comprises arriving at a first milestone location associated with the first milestone event.

Optionally, determining whether the current entrance-behaviour of the at least one person has a requisite correlation with the at least one reference entrance-behaviour may comprise determining whether the current entrance-behaviour comprises arriving at or within a predefined proximity to the first milestone location within a first predefined time frame. The first predefined time frame may be associated with a time-related milestone feature of the first milestone event, for example a predefined amount of time having passed since a human entered the region or since a triggering event.

In some embodiments, the one or more aspects of behaviour comprises arriving at a second milestone location associated with a second milestone event. Optionally, determining whether the current entrance-behaviour of the at least one person has a requisite correlation with the at least one reference entrance-behaviour may further comprise determining whether the current entrance-behaviour comprises arriving at or within a predefined proximity to the second milestone location within a second predefined time frame. The second predefined time frame may be associated with a time-related milestone feature of the second milestone event. The time-related feature of the second milestone event may, for example, comprise a predefined amount of time having passed since a human entered the region or since a triggering event or since arriving at or leaving the first milestone location.

In some embodiments, the at least one reference-entrance-behaviour comprises traversing at least part of the region according to a travel-path and/or through a pathway.

Optionally the travel-path and/or pathway may be defined as commencing at a location at which a human is first detected in the first set of RARWD measurements, which may be after an away period in which the region is determined to be vacant, optionally determined to be vacant for at least a minimum amount of time, e.g. 30 seconds or 1 minute.

In some examples, the at least one reference-entrance-behaviour comprises traversing at least part of the region according to a travel-path.

Optionally, determining whether the current entrance-behaviour of the at least one person has a requisite correlation with the at least one reference entrance-behaviour may comprise determining whether the current entrance-behaviour comprises traversing at least part of the region according to a current travel-path that has a requisite consistency with a travel-path in the at least one reference entrance-behaviour.

The requisite consistency may comprise a minimum correlation. The requisite consistency may comprise that the current travel-path has a current path length having a minimum correlation with a reference path length of a travel-path in the at least one reference entrance-behaviour. The requisite consistency may include that the current travel-path have a start location and an end location that are the same or within a predefined maximum distance of a respective start location and end location of said travel-path in the at least one reference entrance-behaviour.

Additionally, or alternatively, the requisite consistency may include that the current travel-path have directional consistency with said travel-path in the at least one reference entrance-behaviour. Optionally, by comparing directional attributes of the current travel-path and said travel-path in the at least one reference entrance-behaviour, it may be determined that the requisite consistency is not met if the current travel-path does not have directional consistency with said travel-path in the at least one reference entrance-behaviour. Thus, even without knowing starting coordinates of the current travel-path and/or said travel-path it may be determined that, with respect of said travel-path, the requisite consistency is not met if there is directional inconsistency. It may for example be concluded that there is directional inconsistency if the current travel-path and said travel-path do not both commence in the same direction, optionally identified after a minimum traversed distance and/or minimized traversal time, within a predefined variation limit, e.g. within 20 degrees.

The current path length having a minimum correlation with the reference path length in the at least one reference entrance-behaviour may comprise the current path length being within a predefined closeness to, or within a predefined or defined threshold of, the reference path length of the at least one reference entrance-behaviour. Being within the predefined closeness may be comprise a difference between the current path length and the reference path length being less than a maximum. As will be understood, the current path length and the reference path length may each be understood as a distance travelled (as opposed to a displacement).

Where the at least one person comprises a plurality of people, the requisite consistency may comprise all of the plurality of people having respective travel-paths all having a requisite correlation with a same reference travel-path. In another embodiment, the at least one reference entrance-behaviour may comprise a plurality of reference entrance-behaviours and different ones of the respective travel-paths may have the requisite correlation with any of a plurality of different reference travel-paths, the different travel-paths representing different reference entrance-behaviours corresponding to respective ones of the plurality of reference entrance-behaviours.

In some examples, the at least one reference-entrance-behaviour may comprise traversing at least part of the region through a pathway. The traversing may be from a first location to a second location, wherein traversing from the first location to the second location may comprise traversing from the first location to the second location without straying from the pathway.

Optionally, determining whether the current entrance-behaviour of the at least one person has a requisite correlation with the at least one reference entrance-behaviour may comprise determining whether the current entrance-behaviour comprises traversing from a starting location (e.g. the first location) to an end location (e.g. the second location) without straying from the pathway.

The method may comprise defining the pathway, wherein the pathway is defined based on one or more travel-paths undertaken by a person in a reference entrance-behaviour of the at least one reference entrance-behaviours.

The pathway may have lateral boundaries that laterally surround all of the one or more travel-paths in the reference entrance-behaviour. The lateral boundaries of the pathway may correspond to a corridor around the one or more travel-paths.

The pathway may be defined as having a predefined maximum width.

Optionally the pathway may have lateral boundaries having a maximum distance from the one or more travel-paths.

Optionally, the pathway may have lateral boundaries having a maximum distance from a representative average of the one or more travel-paths.

Where the one or more travel-paths comprises multiple travel-paths, the multiple travel-paths may be determined to represent a single reference entrance-behaviour based on the multiple travel-paths having a predetermined correlation with each other. For example, if a particular set of travel-paths are at least one or all of: a similar shape, have similar path lengths, and/or commence and end at similar locations, they may be determined to represent a single reference entrance-behaviour.

Where the at least one person comprises a plurality of people, determining whether the at least one person has a current travel-path that remains within a reference pathway may comprise determining that all of the plurality of people remain within a same reference pathway or within any one or more of a plurality of different reference pathways.

Optionally, the at least one reference entrance-behaviour may be dependent on contextual conditions, wherein the current entrance-behaviour occurs under said contextual conditions. In an example, the reference entrance-behaviour may be dependent on an occupancy, or lack thereof, prior to the reference entrance-behaviour and prior to the current entrance-behaviour. Additionally, or alternatively, the reference entrance-behaviour may be dependent on a time of entry into the region, e.g. time of day. For example, when returning home from after a certain night-time hour, parents may be found to habitually stop by the bedrooms of each child before continuing to their own bedroom. Thus, such a reference entrance-behaviour may be relevant to comparable conditions, e.g. during the same hour or other time period and/or when it is determined that children are at home and/or in their bedrooms prior to the arrival home of the parents. In these examples, the determining whether the current entrance-behaviour of the at least one person has a requisite correlation with the at least one reference entrance-behaviour to determine whether a normal entrance-behaviour condition is satisfied comprises determining whether the current entrance-behaviour of the at least one person has a requisite correlation with at least one reference entrance-behaviour that matches the contextual conditions and/or time of entry of the current entrance-behaviour of the at least one person.

The triggering event may comprise an indication of an object-entry event that may be an actual or likely human-entry event. Optionally the object-entry event may be limited to occasions in which the region is unoccupied, i.e. vacant, prior to the object-entry event. The object-entry event may be an event associated with or indicative of entry of an object into the region being monitored, e.g. from outwith the region being monitored. For example, an object-entry event associated with or indicative of entry of an object into the region may comprise an event performed or occurring on entry into the region. Optionally, an object-entry event associated with or indicative of entry of an object into the region may comprise or consist of an entry of an object into the region being monitored from outwith the region being monitored.

The current-entrance-behaviour and optionally the reference entrance-behaviour may be behaviours of entering the region immediately following a period in which the region is vacant. Optionally the region may be determined to be vacant using the at least one RARWD. The term vacant or unoccupied as used herein may optionally be interpreted to mean vacant of humans or unoccupied by humans.

In some examples, the method may comprise determining when the region is vacant of humans prior to the object-entry event, e.g. by using the at least one RARWD to determine when the region is vacant of humans prior to the object-entry event, wherein the current entrance-behaviour may be an entrance-behaviour that is determined to follow a time during which the region is determined to be vacant of humans. In other words, the current entrance-behaviour may be such that immediately prior an occurrence of the current entrance-behaviour the region is determined to be vacant of humans.

In some embodiments, the object-entry event may be a specific one or may be any of:
a full or partial disarming of a security system associated with the region;
a detected change in a door state of a door associated with the region;
a detected passage of a person through an entry associated with the region or a physically partitioned portion therein (e.g. a room, where the region includes more than the room), e.g. using a curtain PIR detector, etc., or using a force or pressure sensor on in a flooring, etc.;
a detected passage of a person into the region, e.g. using a directional curtain PIR detector, or a barrier detector based on beam interruption, etc.;
a detected presence or motion at an entry location at which the region may be entered, e.g. by a motion sensor or presence sensor positioned to monitor the entry; or
a moment at which an object is detected as entering the region, based on RARWD measurements.

The door associated with the region may be a door for entering the region or a physically partitioned part thereof. The detected change in a door state may be or comprise a detecting door-opening event, e.g. using a door state detector, optionally limited to door-opening event determined to be opened from outside the region.

The reference here to “any of” (in juxtaposition with “a specific one”) means that, if for example there is a door sensor and an entry passage detector present, then both have the ability to trigger the same human entry event. That is, the system need not necessarily distinguish between the different ways in which the person may enter, though in some examples the system may do this.

Depending on the application, the object-entry event may be an event in which an object actually is detected as entering the region and/or may be an event in in which an object is likely to be entering the region, e.g. due to a detected event occurring at an entrance to the region, such as at a door.

The region may be or comprise an indoor space or an outdoor space or may comprise both indoor and outdoor spaces.

The region may comprise at least a region adjacent an entry of a residence.

The region may comprise one or more functionally distinct spaces within a building, e.g. one or more of an entrance, a living room, one or more bedrooms, a hallway, and/or the like.

The region may comprise a portion of a premises that is exterior to a building on the premises, e.g. a land-only portion, such as a yard.

The region may be a security-monitored area of a premises for identifying intruders into the premises or a part thereof.

The at least one reference entrance-behaviour may comprise human transit behaviour from a monitored perimeter to one or more entrances, or a specific entrance, to the building.

The output could be or comprise an alarm or it could be or comprise a notification, or may comprise both.

The output may be or comprise a transmitted notification that in some examples is transmitted wirelessly. Additionally, or alternatively the output may comprise an audible and/or visual output.

The at least one RARWD may comprise at least one RADAR, which may comprise at least one multidimensional RADAR, optionally a 3-dimensional RADAR.

In some embodiments, the at least one RARWD may comprises a plurality of RARWDs, optionally a plurality of 3-dimensional RADARs.

In some embodiments, RARWD measurements may represented as one or more point clouds of data determined from raw data from the at least one RARWD. The point cloud may optionally represent reflection locations from which a mass that causes the reflection is moving. In other examples, the use of such a point cloud may not be used. In some embodiments, the RARWD measurements may represent raw data from a RARWD transceiver, which may be without filtering based on object movement.

The method may comprise instructing the at least one RARWD to emit waves to measure the first set of RARWD measurements, and instructing the at least one RARWD to emit waves to measure the second set of RARWD measurements.

In some examples, the at least one RARWD consists of one RARWD.

In some examples, where at least one RARWD comprises a plurality of RARWDs, the first and second sets of RARWD measurements may each comprise measurements from the plurality of RARWDs.

The method may be performed by a single device, e.g. by a device that comprises the at least one RARWD. The method may be performed by a plurality of devices, e.g. the performance of the method may be distributed over a plurality of different devices that may be remote from each other. For example, at least one or more, any or all of: the receiving of the first set of RARWD measurements, the learning at least one reference entrance-behaviour, the receiving of the second set of RARWD measurements and/or the determining of the current entrance-behaviour of the at least one person, may be performed on a first device, which may be a single device, e.g. a device that comprises the at least one RARWD. At least one or more, any or all of: the learning at least one reference entrance-behaviour, the determining whether the current entrance-behaviour of the at least one person has a requisite correlation with the at least one reference entrance-behaviour and/or the generating an output for indicating whether a normal entrance-behaviour condition is determined to be satisfied may be performed by a different device or system, such as a remote processing system that is remote and/or at a different location or premises. The first device and the different device or system may be configured to communicate, e.g. via wired and/or wireless connections. The first device may be configured to communicate the current entrance-behaviour of at least one person and/or the at least one reference entrance-behaviour to the different device or system. For example, the Ranging Active Reflective Wave Detector (RARWD) measurements could be made by a device that comprises the at least one RARWD. The learning of the at least one reference entrance-behaviour based on the first set of RARWD measurements, which could be based directly on the first set of RARWD measurements or any suitable data derived therefrom, could be performed by the same device that comprises the at least one RARWD, by a local processing device such as a hub and/or a remote processing device such as a server, or distributed over any combination thereof. The local device may be a device in the same premises, communicating over a LAN and/or configured for wired or short-range wireless, e.g. Bluetooth, Wi-Fi or ZigBee communications or the like, with the device that comprises the at least one RARWD. The remote device may be device in a remote premises and/or in communication with the device that comprises the at least one RARWD and/or with the hub via the internet, a WAN and/or over a cellular communications network. Any required data, such as the first set of RARWD measurements or any suitable data derived therefrom, the at least one reference entrance-behaviour, and/or the like may be communicated to allow the required processing on different devices to be achieved.

The first set or RARWD measurements may be measurements observed by the same RARWD or the first set of RARWD measurements may be measurements observed by a plurality of RARWDs. Each RARWD measurement of the first set of RARWD measurements may be observed by the same at least one RARWD or at least one RARWD measurement of the first set of RARWD measurements may be observed by a different RARWD to at least one other of the first set of RARWD measurements.

The second set of RARWD measurements may be observed by the same at least one RARWD as the first set of measurements. The second set of RARWD measurements may be observed by at least one different RARWD to the at least one RARWD used to collect the first set of measurements.

According to a second aspect of the present disclosure is a processing system configured for monitoring a region to detect an intruder. The processing system may be configured to:
receive a first set of Ranging Active Reflective Wave Detector (RARWD) measurements for tracking human position in multiple spatial dimensions within a region observed by at least one RARWD;
obtain at least one reference entrance-behaviour based on the first set of RARWD measurements, the at least one reference entrance-behaviour defining at least one normal human transit behaviour through at least part of the region following a detected triggering-event associated with entry into the region, the at least one normal human transit behaviour comprising a characteristic defined in multiple spatial dimensions;
after receiving the first set of RARWD measurements, receive a second set of RARWD measurements to monitor for an intruder into the region;
determine from the second set of RARWD measurements a current entrance-behaviour of at least one person following a detected triggering-event associated with entry into the region, the current entrance-behaviour being determined with respect to multiple spatial dimensions;
determine whether the current entrance-behaviour of the at least one person has a requisite correlation with the at least one reference entrance-behaviour to determine whether a normal entrance-behaviour condition is satisfied; and
generate an output for indicating whether a normal entrance-behaviour condition is determined to be satisfied.

The at least one reference entrance-behaviour may be a learned at least one reference entrance-behaviour that is learned based on the first set of RARWD measurements. The processing system may be configured to learn the at least one reference entrance-behaviour based on the first set of RARWD measurements. The processing system may be configured to receive the at least one reference entrance-behaviour from a different device, which may be a different device local to the processing system such as a hub, or a remote device such as a server. The different device may be configured to learn the at least one reference entrance-behaviour based on the first set of RARWD measurements.

The processing system may be comprised in the at least one RARWD or in a single device that comprises the at least one RARWD. The first set and second set of RARWD measurements may be observed by a single RARWD, and the processing system may be comprised in a single device that comprises the single RARWD. The processing system may comprise one or more processors. The processing system may comprise data storage accessible by the one or more processors. The processing system may be comprised in a remote system that is physically separate from the at least one RARWD, wherein the remote system may be configured to receive communications from the at least one RARWD, e.g. to receive at least the first set and second set of RARWD measurements. The remote system may be located in the same premises as the at least one RARWD, or away from the premises, such as connected by a WAN or comprised in a server or cloud computing resource, or distributed between in premises and off premises remote systems. The processing system may be configured to raise an alarm dependent at least in part on the output for indicating whether a normal entrance-behaviour condition is determined to be satisfied, e.g. if the normal entrance-behaviour condition is not satisfied. The processing system may be a distributed processing system that is distributed over a plurality of devices that comprise at least one, any or all of: the at least one RARWD and/or the remote system.

At least one or more, any or all of: the receiving of the first set of RARWD measurements, the learning at least one reference entrance-behaviour, the receiving of the second set of RARWD measurements and/or the determining of the current entrance-behaviour of the at least one person, may be performed on the single device, e.g. the single device that comprises the at least one RARWD. At least one or more, any or all of: the determining whether the current entrance-behaviour of the at least one person has a requisite correlation with the at least one reference entrance-behaviour and/or the generating an output for indicating whether a normal entrance-behaviour condition is determined to be satisfied may be performed by a different device or system, such as the remote system, e.g. the remote system that is remote and/or at a different location or premises. The single device may be configured to communicate the current entrance-behaviour of at least one person and/or the at least one reference entrance-behaviour to the different device or system.

The processing system may be configured to perform the method of the first aspect.

According to a third aspect of the present disclosure is a system configured for monitoring a region to detect an intruder, the system comprising a plurality of Ranging Active Reflective Wave Detectors (RARWDs). The system may be configured to:
collect a first set of RARWD measurements for tracking human position in multiple spatial dimensions within a region observed by at least one RARWD of the plurality of RARWDs;
obtain at least one reference entrance-behaviour based on the first set of RARWD measurements, the at least one reference entrance-behaviour defining at least one normal human transit behaviour through at least part of the region following a detected triggering-event associated with entry into the region, the at least one normal human transit behaviour comprising a characteristic defined in multiple spatial dimensions;
after receiving the first set of RARWD measurements, receive a second set of RARWD measurements observed by at least one RARWD of the plurality of RARWDs to monitor for an intruder into the region;
determine from the second set of RARWD measurements a current entrance-behaviour of at least one person following a detected triggering-event associated with entry into the region, the current entrance-behaviour being determined with respect to multiple spatial dimensions;
determine whether the current entrance-behaviour of the at least one person has a requisite correlation with the at least one reference entrance-behaviour to determine whether a normal entrance-behaviour condition is satisfied; and
generate an output for indicating whether a normal entrance-behaviour condition is determined to be satisfied.

The at least one reference entrance-behaviour may be a learned at least one reference entrance-behaviour that is learned based on the first set of RARWD measurements. The system may be configured to learn the at least one reference entrance-behaviour based on the first set of RARWD measurements. The learning may be performed on a device comprising at least one RARWD sensor and which collected the RARWD measurements. The learning may be performed on a different device to the device comprising at least one RARWD sensor and which collected the RARWD measurements. The different device may be local, e.g. in the same premises, or remote to the device comprising at least one RARWD sensor and which collected the RARWD measurements. The system may comprise the different device. The system may be configured to communicate with the different device, e.g. to transmit the first set of RARWD measurements tot eh different device and/or to receive the at least one reference entrance-behaviour from the different device.

Each of the RARWDs of the plurality of RARWDs may be remote from each other. The first set of RARWD measurements may be measurements observed by the plurality of RARWDs. At least one RARWD measurement of the first set of RARWD may be observed by a different RARWD detector to at least one other of the first set of RARWD measurements. The second set of RARWD measurements may be observed by the same RARWDs as the first set of measurements. The second set of RARWD measurements may be observed by at least one different RARWD to the at least one RARWD used to collect the first set of measurements.

At least one or more, any or all of: the receiving of the first set of RARWD measurements, the learning at least one reference entrance-behaviour, the receiving of the second set of RARWD measurements and/or the determining of the current entrance-behaviour of the at least one person, may be performed on a device that comprises the RARWD used to collect the RARWD measurement.

At least one or more, any or all of: the determining whether the current entrance-behaviour of the at least one person has a requisite correlation with the at least one reference entrance-behaviour and/or the generating an output for indicating whether a normal entrance-behaviour condition is determined to be satisfied may be performed by a processing system that may be physically separate and/or remote from, e.g. at a different location or premises as. The plurality of RARWDs, or at the same premises as the plurality of RARWDs. The devices comprising the RARWDs of the plural of RARWDs may be configured to communicate with the processing system, e.g. via wired and/or wireless connections. The devices comprising the RARWDs of the plural of RARWDs may be configured to communicate the current entrance-behaviour of at least one person and/or the at least one reference entrance-behaviour to the processing system.

The processing system may be the processing system of the second aspect. The system may be configured to implement the method of the first aspect.

According to a fourth aspect of the present disclosure is a non-transitory computer readable carrier medium having stored thereon instructions configured such that, when executed by a processing system, configure the processing system to monitor a region to detect an intruder, optionally using a process comprising:
receiving a first set of Ranging Active Reflective Wave Detector (RARWD) measurements for tracking human position in multiple spatial dimensions within a region observed by at least one RARWD;
obtaining at least one reference entrance-behaviour based on the first set of RARWD measurements, the at least one reference entrance-behaviour defining at least one normal human transit behaviour through at least part of the region following a detected triggering-event associated with entry into the region, the at least one normal human transit behaviour comprising a characteristic defined in multiple spatial dimensions;
after receiving the first set of RARWD measurements, receiving a second set of RARWD measurements to monitor for an intruder into the region;
determining from the second set of RARWD measurements a current entrance-behaviour of at least one person following a detected triggering-event associated with entry into the region, the current entrance-behaviour being determined with respect to multiple spatial dimensions;
determining whether the current entrance-behaviour of the at least one person has a requisite correlation with the at least one reference entrance-behaviour to determine whether a normal entrance-behaviour condition is satisfied; and
generating an output for indicating whether a normal entrance-behaviour condition is determined to be satisfied.
The process may be or comprise the method of the first aspect.

The at least one reference entrance-behaviour may be a learned at least one reference entrance-behaviour that is learned based on the first set of RARWD measurements. The process may comprise learning the at least one reference entrance-behaviour that is learned based on the first set of RARWD measurements.

The instructions may be provided on one or more carriers. For example, there may be one or more non-transient memories, e.g. a EEPROM (e.g. a flash memory) a disk, CD- or DVD-ROM, programmed memory such as read-only memory (e.g. for Firmware), one or more transient memories (e.g. RAM), and/or a data carrier(s) such as an optical or electrical signal carrier. The memory/memories may be integrated into a corresponding processing chip and/or separate to the chip. Code (and/or data) to implement embodiments of the present disclosure may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language. The computer readable carrier medium may be a non-transient and/or physical computer readable carrier medium.

The carrier medium may be a single physical carrier medium or may be distributed over a plurality of different physical carrier media, which may be located locally or remotely from each other. The process may be carried out on a single device or distributed over multiple devices, at least one or all of which may be local to each other or may be remote from each other.

According to a fifth aspect of the present disclosure is a device configured for monitoring a region to detect an intruder, the device comprising at least one Ranging Active Reflective Wave Detector (RARWD). The device may be configured to:
collect a first set of RARWD measurements for tracking human position in multiple spatial dimensions within a region observed by the at least one RARWD;
obtain at least one reference entrance-behaviour based on the first set of RARWD measurements, the at least one reference entrance-behaviour defining at least one normal human transit behaviour through at least part of the region following a detected triggering-event associated with entry into the region, the at least one normal human transit behaviour comprising a characteristic defined in multiple spatial dimensions;
after receiving the first set of RARWD measurements, receive a second set of RARWD measurements observed by the at least one RARWD to monitor for an intruder into the region;
determine from the second set of RARWD measurements a current entrance-behaviour of at least one person following a detected triggering-event associated with entry into the region, the current entrance-behaviour being determined with respect to multiple spatial dimensions;
determine whether the current entrance-behaviour of the at least one person has a requisite correlation with the at least one reference entrance-behaviour to determine whether a normal entrance-behaviour condition is satisfied; and
responsive to the determining of whether the normal entrance-behaviour condition is satisfied, controlling output indicative of whether the normal entrance-behaviour condition is determined to be satisfied.

The at least one reference entrance-behaviour may be a learned at least one reference entrance-behaviour that is learned based on the first set of RARWD measurements. The device may be configured to learn the at least one reference entrance-behaviour based on the first set of RARWD measurements. The device may be configured to obtain the at least one reference entrance-behaviour from a different local device or a remote system such as a server.

The device may be configured to implement the method of the first aspect. The device may be a unitary device. The device may comprise a processor, e.g. for implementing the method of the first aspect, or may comprise the processing system of the second aspect. The processor or processing system may be within a supported on a common frame and/or housed in a common housing with the at least one RARWD.

According to a sixth aspect of the present disclosure is a computer-implemented method for monitoring a region to detect an intruder, the method comprising:
receiving a first set of Ranging Active Reflective Wave Detector (RARWD) measurements for tracking human position in multiple spatial dimensions within a region observed by at least one RARWD;
obtaining at least one reference pathway based on the first set of RARWD measurements, the at least one reference pathway defining a normal pathway traversed by at least one human through at least part of the region following a detected triggering-event associated with entry into the region, the at least one pathway being defined in multiple spatial dimensions;
after receiving the first set of RARWD measurements, receiving a second set of RARWD measurements to monitor for an intruder into the region;
determining from the second set of RARWD measurements, a current pathway traversed by at least one person following a detected triggering-event associated with entry into the region, the current pathway of the at least one person being determined in multiple spatial dimensions;
determining whether the current pathway has a requisite correlation with the at least one reference pathway to determine whether a normal entrance-behaviour condition is satisfied; and
responsive to the determining of whether the normal entrance-behaviour condition is satisfied, controlling output indicative of whether the normal entrance-behaviour condition is determined to be satisfied.

The at least one reference entrance-behaviour may be a learned at least one reference entrance-behaviour that is learned based on the first set of RARWD measurements. The method may comprise learning the at least one reference entrance-behaviour based on the first set of RARWD measurements.

The first set of RARWD measurements may represent the location of the at least one human as they traverse through the at least part of the region. The second set of RARWD measurements may represent the location of the at least one person as they traverse the current pathway. The triggering event may be determined using a different device to the at least one RARWD, such as a PIR motion detector, and/or may be determined using the at least one RARWD.

Optionally, the pathway, e.g. the at least one reference pathway and/or the current pathway, may be defined as extending from a location at which a human is first detected, which may be after an away period in which the region is determined to be vacant, optionally determined to be vacant for at least a minimum amount of time, e.g. 30 seconds or 1 minute.

The at least one reference pathway may extend, e.g. extend continuously, from a first location to a second location. The first location may be the location at which the human is first detected in the first set of RARWD measurements. The second location may be a location such as an end location of, or along, the normal pathway traversed by the human from the first location. The determining of whether the current pathway of the at least one person has the requisite correlation with the at least one reference pathway may comprise determining, based on the second set of RARWD measurements, if the at least one person traversed from the first location to the second location without straying from the at least one reference pathway.

The method may comprise defining the at least one reference pathway, wherein the at least one reference pathway may be based on the at least one travel-path represented in the first set of RARWD, the at least one travel path being undertaken by the human traversing through the at least part of the region following the detected triggering-event associated with entry into the region. For example, the reference pathway may comprise the at least one travel path represented in the first set of RARWD, or a function of the one or more travel paths represented in the first set of RARWD measurements such as a representative average, mean or cluster of the one or more travel paths. The reference pathway may be centred on the function of the one or more travel paths represented in the first set of RARWD measurements, e.g. on the representative average or mean or cluster of the one or more travel paths.

The pathway may have lateral boundaries that laterally surround all of, or the function of, the one or more travel-paths on which the pathway is based. The lateral boundaries of the pathway may correspond to a corridor around the one or more travel-paths or the function of the one or more travel-paths.

The pathway may be defined as having a predefined maximum width.

Optionally the pathway may have lateral boundaries having a maximum distance from the one or more travel-paths.

Optionally, the pathway may have lateral boundaries having a maximum distance from a representative average or other function of the one or more travel-paths.

The determining of whether the current pathway has a requisite correlation with the at least one reference pathway may comprise determining if the at least one person traverses though the region along at least part or all of one or any of the at least one reference pathways whilst remaining within the lateral boundaries of the said reference pathway. For example, the determining if the at least one person traversed from the first location to the second location without straying from the at least one reference pathway may comprise determining, based on the second set of RARWD, if the at least one person traversed from the first location to the second location whilst remaining within the lateral boundaries of said reference pathway.

The at least one reference pathway may comprise a plurality of reference pathways. In some examples determining whether the current pathway has a requisite correlation with the at least one reference pathway may comprise determining whether the current pathway has a requisite correlation with any reference pathway of the least one reference pathways. In other examples determining determine whether the current pathway has a requisite correlation with the at least one reference pathway may comprise determining whether the current pathway has a requisite correlation with a particular reference pathway of the least one reference pathways.

The at least one person may be a predefined number of persons. In other embodiments, the at least one person may be any number of persons up to and including a predefined maximum number of persons. Optionally, the at least one person is every one of one or more people represented in the second set of RARWD measurements. In examples, the at least one person may be a subset of a plurality of people represented in the second set of RARWD measurements.

Where the at least one person comprises a plurality of people, determining if the at least one person traversed from the first location to the second location without straying from the at least one reference pathway may comprise determining that all of the plurality of people remain within a same reference pathway or within any one or more of a plurality of different reference pathways.

The normal entrance-behaviour condition being satisfied may be indicative of the at least one person not being an intruder. The normal entrance-behaviour condition not being satisfied may be indicative of the at least one person being or comprising an intruder.

The method may be performed by an intruder detection system, such as an intruder alarm system, or a system with intruder alarm functionality. The method may comprise performing an intruder action, such as at least one of: raising an alarm, performing a verification action, sending an electronic, visual or audio notification to one or more recipients, performing a deterrent action, or performing at least one other intruder potentially present action, dependent at least in part on the output being indicative of the normal entrance-behaviour condition having been determined not to be satisfied. The performance of the intruder action may be carried out by a device that comprises the at least one RARWD and/or the output may be transmitted directly or indirectly to at least one remote device to perform the intruder action based on the output. In some examples, the method is implemented while the alarm system is not in an armed state. Optionally the alarm system may operate without arming states. The at least one reference entrance-behaviour may not include a time taken to disarm an alarm system. The at least one reference entrance-behaviour may not involve disarming an alarm system.

The method may be performed on a single device or distributed over a plurality of different devices, which may be local or remote from each other. The method may be performed, at least in part, by a device that collects the first set of RARWD measurements. The method may be performed, at least on part, on a different device to the device that collects the first set of RARWD measurements and/or a device that determines the current entrance-behaviour and/or determines whether the current entrance-behaviour of the at least one person has a requisite correlation with the at least one reference entrance-behaviour. The different device may be local or remote to the device that collects the first set of RARWD measurements. Local may comprise being in the same premises and/or configured to communicate via a local area network and/or via a short range wired or wireless communications such as Wi-Fi, Bluetooth, ZigBee or the like. Remote may comprise being in a different premises and/or may comprise being configured to communicate over the internet, cellular telecommunications network and/or a wide area network.

Any of the features described above in relation to the first aspect may be individually or in combination in the method of the sixth aspect.

According to further aspects of the present disclosure are a system, a device and/or a computer program product configured to implement the method of the sixth aspect. The device may comprise at least one RARWD and at least one processor. The system may comprise a processor and data storage. The system may comprise the device.

According to a seventh aspect of the present disclosure is a computer-implemented method for monitoring a region to detect an intruder, the method comprising:
receiving a first set of Ranging Active Reflective Wave Detector (RARWD) measurements for tracking human position in multiple spatial dimensions within a region observed by at least one RARWD over time;
obtaining at least one milestone based on the first set of RARWD measurements, each milestone comprising a milestone location on a normal travel-path taken by a human through at least part of the region following a detected triggering-event associated with entry into the region and a corresponding milestone time, the one or more milestone locations being defined in multiple spatial dimensions;
after receiving the first set of RARWD measurements, receiving a second set of RARWD measurements to monitor for an intruder into the region;
determining, from the second set of RARWD measurements, whether a traversal of at least one person through at least part of the region following a detected triggering-event associated with entry into the region has a requisite correlation with the respective milestone location and the corresponding milestone time for any, some or all of the at least one milestones, the second set of RARWD measurements being indicative of a location of the at least one person in multiple spatial dimensions;
determining whether a normal entrance-behaviour condition is satisfied based on the determination of whether the traversal of the at least one person has the requisite correlation with the respective milestone location and the respective milestone time for at least one, any or all of the at least one milestones; and
responsive to the determining of whether the normal entrance-behaviour condition is satisfied, controlling output indicative of whether the normal entrance-behaviour condition is determined to be satisfied.

The at least one reference entrance-behaviour may be a learned at least one reference entrance-behaviour that is learned based on the first set of RARWD measurements. The method may comprise learning the at least one reference entrance-behaviour based on the first set of RARWD measurements.

The milestone time may be a time elapsed following a detected triggering-event associated with entry into the region or a time elapsed since a previous milestone was achieved by the human, e.g. since the person arrived at a previous milestone location.

The determining of whether the traversal of at least one person across at least part of the region has the requisite correlation with the at least one milestone location may comprise determining whether the traversal of the at least one person across the at least part of the region includes the person being within a defined or predefined proximity to the at least one milestone location. Optionally, the determining of whether the traversal of at least one person across at least part of the region has the requisite correlation with the at least one milestone location and the corresponding milestone time may comprise the at least one person being within the defined or predefined proximity to the milestone location within a time frame comprising the corresponding milestone time. The time frame may be associated with a time-related milestone feature of the milestone, for example a predefined amount of time having passed since a human entered the region or since a triggering event or since a previous milestone was achieved by the human, e.g. since the person human at a previous milestone location. The defined or predefined proximity to the milestone location may optionally be the person being exactly at the milestone location. The time frame comprising the corresponding milestone time may be exactly at the milestone time. The defined or predefined proximity to the milestone location and/or the time frame may be set or pre-set, e.g. responsive to manual input, or may be calculated. The calculation of the defined or predefined proximity to the milestone location and/or the time frame may be based on the first set of RARWD measurements, e.g. based on a variation or spread in the milestone location and/or the milestone time for that milestone represented in the first set of RARWD measurements.

The milestone locations may be or comprise a point, an area or a volume. The dimensions of the area or volume may be defined or predefined or calculated based on a distribution of locations for the milestone represented in the first set of RARWD measurements. The milestone times may be or comprise an exact moment in time or a time range. The time range may be defined, or predefined, or calculated based on a distribution of arrival times at the corresponding milestone location represented in the first set of RARWD measurements.

If it is determined that the at least one person arrived at the one or more or all of the at least one milestone locations, or was within a predefined proximity to the milestone location, at the respective milestone time, or within the time frame comprising the corresponding milestone time, then the traversal of at least one person across at least part of the region may have the requisite correlation. If it is determined that the at least one person arrived at the one or more or all of the at least one milestone locations within the respective milestone time frame, then the traversal of at least one person across at least part of the region may have the requisite correlation. If it is determined that the at least one person did not arrive at the one or more or all of the at least one milestone locations, or was not within a predefined proximity to the milestone location, according to the respective milestone time, then the traversal of at least one person across at least part of the region may not have the requisite correlation. If it is determined that the at least one person did not arrive at the one or more or all of the at least one milestone locations within the respective milestone time frame then the traversal of at least one person across at least part of the region may not have the requisite correlation.

The at least one milestone may comprise plurality of milestones.

The at least one milestone may comprise a first milestone having a first milestone location and being associated with a first milestone time. The at least one milestone may comprise a second milestone having a second milestone location and being associated with a second milestone time. The second milestone time may be different to the first milestone time. For example, the second milestone may relate to a later instance of stopping walking compared to the first milestone. However, in other examples, the second milestone time may be the same as the first milestone time. This may occur, for example, if the second milestone is not dependent on the first milestone. There may optionally be further milestones in addition to the first and second milestones.

The milestones of the plurality of milestones may be sequential, i.e. in an ordered sequence. The determining of whether the traversal of at least one person across at least part of the region has the requisite correlation may comprise determining whether the at least one person traversing at least part of the region arrived at the respective milestone location, or was within the predefined proximity to the milestone location, at the respective milestone time for some or all of the at least one milestones in a same order as in the ordered sequence.

However, the milestones need not be in a sequence. For example, the first and second milestones need not be sequential or otherwise part of a sequence, in some examples they may be independent of each other.

Each milestone may be discrete, e.g. not part of a pathway. The determining of whether the traversal of at least one person across at least part of the region has the requisite correlation may not depend on the route that the at least one person took between milestone locations.

The milestone locations, e.g. the first milestone location and/or the second milestone location, may be defined in multiple spatial dimensions (e.g. with reference to 3D coordinates).

The method may comprise analysing the first set of RARWD measurements to identify at least one milestone event corresponding to at least one or all milestones of the at least one milestone based on a detected object performing one or more predefined milestone features of the respective milestone event. Each milestone may be defined by the milestone event being performed at the milestone location at the milestone time following a detected triggering-event associated with entry into the region.

The milestone events may optionally comprise any one or more of the following milestone features:
human travel of a predefined distance since being at a defined previous location, e.g. a location of entering the region or of a preceding milestone location;
human travel of a predefined displacement from a defined previous location, e.g. a location of entering the region or of a preceding milestone location;
a predefined amount of time having passed since a human entered the region or since a triggering event or since a preceding milestone event;
changing speed of movement in a predetermined manner by a human, after commencing a transit through at least part of the region; and
changing direction of movement in a predetermined manner by a human after commencing a transit through at least part of the region.

For the second milestone and/or milestones in the sequence of milestones after a first milestone in the sequence of milestones, the defined previous location may optionally be the first milestone location or a milestone location of a preceding milestone in the sequence of milestones.

The changing speed of movement in a predetermined manner may comprise stopping or pausing.

In some examples, the one or more milestone features of the milestone events may comprise a changing speed of movement in a predetermined manner by a human, after commencing a transit through at least part of the region. The predetermined manner may be changing speed from a non-zero speed to being stationary. The non-zero speed may be a predefined minimum walking speed or within a predefined walking speed range.

The method may be performed on a single device or distributed over a plurality of different devices, which may be local or remote from each other. The method may be performed, at least in part, by a device that collects the first set of RARWD measurements and/or may be performed, at least on part, on a different device, which may be local or remote to the device that collects the first set of RARWD measurements.

Any of the features described above in relation to the first aspect may be individually or in combination in the method of the sixth aspect.

According to further aspects of the present disclosure are a system, a device and/or a computer program product configured to implement the method of the seventh aspect.

The individual features and/or combinations of features defined above in accordance with any aspect of the present invention or below in relation to any specific embodiment of the invention may be utilised, either separately and individually, alone or in combination with any other defined feature, in any other aspect or embodiment of the invention.

Furthermore, the present invention is intended to cover apparatus configured to perform any feature described herein in relation to a method and/or a method of using or producing, using or manufacturing any apparatus feature described herein. The apparatus may, for example, comprise or consist of a device or system of any aspect of the invention described herein.

These and other aspects will be apparent from the embodiments described in the following. The scope of the present disclosure is not intended to be limited by this summary nor to implementations that necessarily solve any or all of the disadvantages noted.

### BRIEF DESCRIPTION OF THE DRAWINGS

For a better understanding of the present disclosure and to show how embodiments may be put into effect, reference is made to the accompanying drawings in which:

FIG. 1 is a schematic of a system for monitoring a region to detect an intruder;

FIG. 2 is a schematic illustration of an alternative system for monitoring a region to detect an intruder;

FIG. 3 is a schematic illustration of a further system for monitoring a region to detect an intruder;

FIG. 4 is a schematic illustration of a sensing device for monitoring a region;

FIG. 5 is a flowchart illustrating a method for monitoring a region to detect an intruder;

FIG. 6 illustrates a human body with indications of reflections measured by a ranging active reflective wave detector;

FIG. 7A is an illustration showing illustrative normal human transit behaviours;

FIG. 7B is an illustration showing alternative illustrative normal human transit behaviours;

FIG. 8 is an illustration showing further illustrative normal human transit behaviours;

FIG. 9 is an illustration showing alternative illustrative normal human transit behaviours;

FIG. 10 is an illustration showing an arrangement of milestones for use in monitoring a region to detect an intruder;

FIG. 11 is an illustration showing alternative arrangement of milestones for use in monitoring a region to detect an intruder;

FIG. 12 is a flowchart illustrating a method for monitoring a region to detect an intruder;

FIG. 13 is a schematic illustration of examples of entrance-behaviour of a person against reference entrance-behaviour;

FIG. 14 is a schematic illustration of formation of a reference pathway;

FIG. 15 is a schematic illustration of use of the reference pathway shown in FIG. 13 to determine current entrance-behaviour of a person in a first scenario;

FIG. 16 is a schematic illustration of use of the reference pathway shown in FIG. 13 to determine current entrance-behaviour of a person in a second scenario;

FIG. 17 is a schematic illustration of use of the reference pathway shown in FIG. 13 to determine current entrance-behaviour involving two persons in a third scenario;

FIG. 18 is a schematic illustration of an alternative approach to monitoring a region to detect an intruder; and

FIG. 19 is a flowchart illustrating a method for monitoring a region to detect an intruder.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized, and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims and their equivalents.

In the following embodiments, like components are labelled with like reference numerals.

In the following embodiments, the term data store or memory is intended to encompass any computer readable storage medium and/or device (or collection of data storage mediums and/or devices). Examples of data stores include, but are not limited to, optical disks (e.g., CD-ROM, DVD-ROM, etc.), magnetic disks (e.g., hard disks, floppy disks, etc.), memory circuits (e.g., EEPROM, solid state drives, random-access memory (RAM), etc.), and/or the like.

The functions or algorithms described herein are implemented in hardware, software or a combination of software and hardware in one or more embodiments. The software comprises computer executable instructions stored on computer readable carrier media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, microcontroller, or other type of processor.

Specific embodiments will now be described with reference to the drawings.

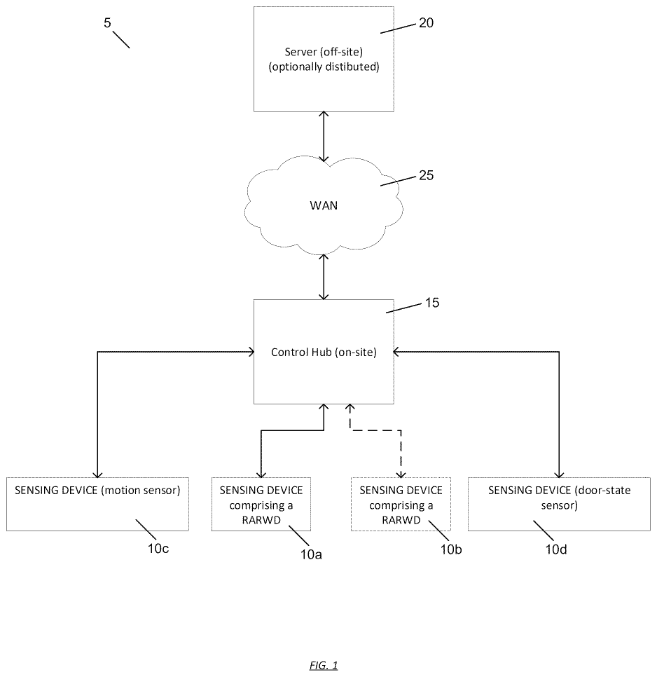

FIG. 1 illustrates one example arrangement of a system 5 for monitoring a region to detect an intruder. The system 5 comprises one or more sensing devices 10a, 10b, 10c, 10d, in communication with a control hub 15.

In this example, there are a plurality of sensing devices 10a, 10b, 10c, 10d, including at least one (and optionally a plurality of) ranging active reflective wave detectors (RARWD) 10a, 10b. Each of the RARWDs could be, for example, a detector comprising a RADAR, or LIDAR or similar detector that emits waves, and collects and processes reflections of the waves to determine presence and location of objects. Each RARWD 10a, 10b is capable of determining a range (i.e. measured distance) and bearing to the object and thus the location of objects in three dimensions. The data generated by each RARWD 10a, 10b is time correlated, e.g. by time stamp, such that it is possible to determine, from the RARWD measurements, the location in three dimensions of each object within the field of view of the RARWD 10a, 10b for any given time.

The sensing devices 10a, 10b, 10c, 10d also include different forms of sensing device other than RARWDs 10a, 10b. For example, the sensing devices could include one or more motion sensors 10c, such as PIR sensors, and one or more door or window state sensors 10d. These are particularly suited to detecting entry into a monitored region but are generally not capable of determining the three-dimensional location of objects.

In this example, the control hub 15 is an on-site control hub (i.e. at the same premises as the sensing devices 10a, 10b, 10c, 10d). The control hub 15 and sensing devices 10a, 10b, 10c, 10d can communicate via wired or wireless communication, and the communications can include, for example, the data generated by each sensing device 10a, 10b, 10c, 10d being communicated to the control hub 15, control commands for controlling or operating the sensing devices 10a, 10b, 10c, 10d and/or the like. The control hub 15 is configured to communicate with a remote server 20 over a WAN or cloud-based communication channel 25. There are several possibilities for processing the data generated by the sensing devices 10a, 10b, 10c, 10d in order to monitor the region to detect intruders. For example, the processing could be performed on the sensing devices 10a, 10b that comprise the at least one RARWD 10a, 10b. Additionally, or alternatively, the processing could be performed on the control hub 15 and/or on the remote server 20 or distributed between any or all of the RARWDs 10a, 10b, the control hub 15 and/or the remote server 20, or any combination thereof.

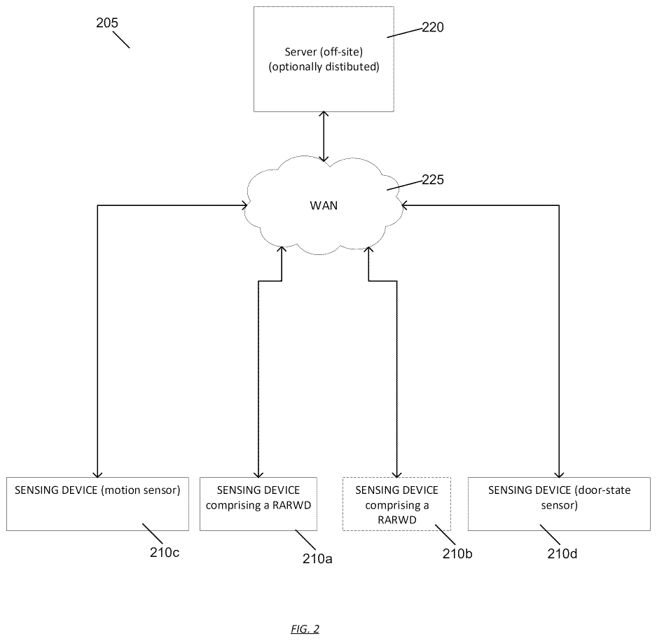

FIG. 2 illustrates an alternative example arrangement of a system 205 for monitoring a region to detect an intruder. The system 205 comprises one or more sensing devices 210a, 210b, 210c, 210d and the remote server 220. Similarly to the arrangement of FIGS. 1, the one or more sensing devices 210a, 210b, 210c, 210d can comprise one or more, e.g. a plurality of, RARWDs 210a, 210b, one or more motion detectors 210c such as PIR detectors and/or one or more door or window opening sensors 210d. However, the system 205 of FIG. 2 differs from that of FIG. 1 in that the sensing devices 210a, 210b, 210c and 210d are configured for internet based communications and thereby to communicate with the remote server 220, optionally over a cellular communications channel, directly over the WAN or cloud based communication channel 25 and there is no local control hub 15. In this example, although all of the processing of the data generated by the one or more sensing devices 210a, 210b, 210c, 210d could be processed entirely on the one or more sensing devices 210a, 210b, 210c, 210d or entirely on the remote server 220, beneficially processing of the data to monitor the region for intruders is distributed between the one or more sensing devices 210a, 210b, 210c, 210d and the remote server 220, which any required data being passed therebetween via the WAN or cloud based communication channel 25.

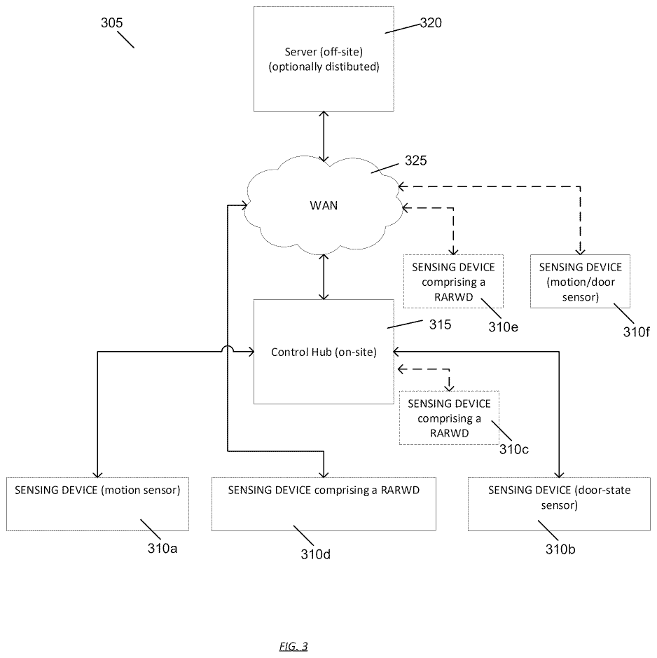

FIG. 3 illustrates a further example arrangement of a system 305 for monitoring a region to detect an intruder. The system 305 of FIG. 3 is, in effect, a hybrid of the systems 5, 205 of FIGS. 1 and 2 in that the system comprises a control hub 315 and a plurality of sensing devices 310a-f, wherein some of the plurality of sensing devices 310a, 310b, 310c communicate with the local control hub 315 and some of the sensing devices 310d, 310e, 310f communicate, optionally over a cellular communications channel, directly with a remote server 320 over the WAN or cloud based communications channel 325 without going through the local control hub 315. The sensing devices 310a-f optionally include different types of sensing device, in this example including a motion sensor 310a, a door or window state sensor 310b and optionally a RARWD 310c that communicate with the local control hub 315 and a plurality of additional or alternative RARWDs 310d, 310e and a further motion or door opening sensor 310f. However, types, numbers and distribution of sensing devices 310a-f is not limited to this and other types, combinations and/or numbers of sensing devices and other distributions of sensing devices between those communicating with a local control hub 315 and those communicating directly with the remote server 320 could be used.

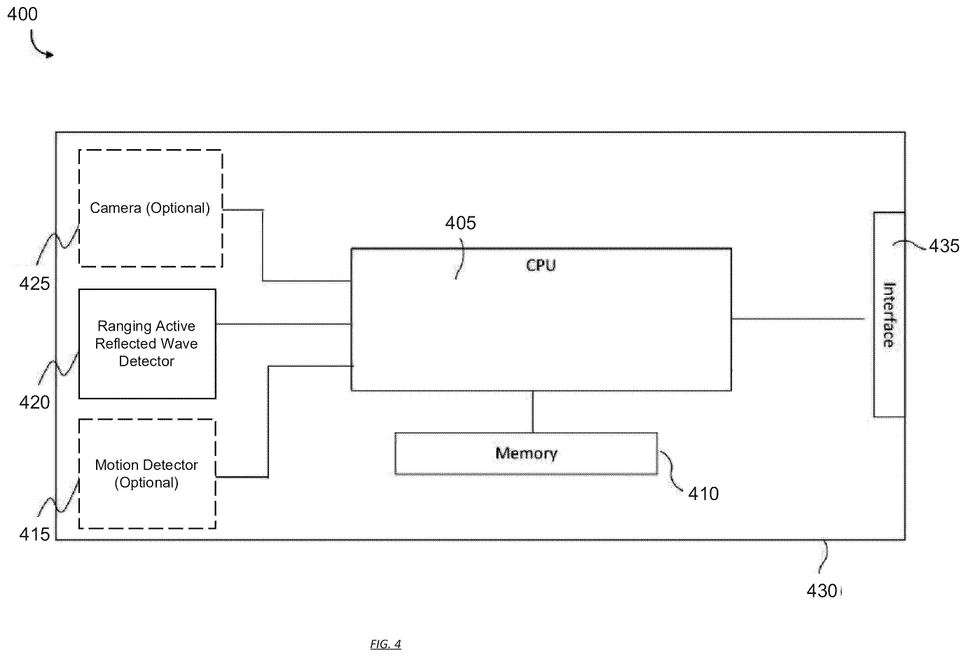

FIG. 4 is a schematic of an example of a sensing device 400 that comprises a RARWD and could optionally be used as any of the sensing devices 10a, 10b, 210a, 210b, 310c, 310d, 310e of any of FIGS. 1 to 3 or as a stand-alone device. In particular, FIG. 4 illustrates a simplified view of the sensing device 400. As shown in FIG. 4, the sensing device 400 comprises a central processing unit (“CPU”) 405, to which is connected a memory 410. The functionality of the CPU 405 described herein could be implemented in code (software) stored on a memory (e.g. memory 410) comprising one or more storage media, and arranged for execution on a processor comprising on or more processing units. The storage media could be integrated into and/or separate from the CPU 405. The code is configured so as to, when fetched from the memory and executed on the processor, perform operations in line with embodiments discussed herein.

Alternatively, it is not excluded that some or all of the functionality of the CPU 405 is implemented in dedicated hardware circuitry (e.g. ASIC(s), simple circuits, gates, logic, and/or configurable hardware circuitry like an FPGA). In other embodiments (not shown) a processing system executes the processing steps described herein, wherein the processing system consists of the processor as described herein or could be comprised of distributed processing devices that are distributed across two or more of the devices shown in the system 5, 205, 305 of any of FIG. 1, 2 or 3. Each processing device of the distributed processing devices optionally comprises any one of more of the processing devices or units referred to herein.

FIG. 4 shows the CPU 405 being connected to an optional motion sensor 415, a ranging active reflected wave detector 420, and optionally a camera 425. While in the illustrated embodiment the motion sensor 415, ranging active reflected wave detector 420, and the camera 425 are separate from the CPU 405, in other embodiments, at least part of processing aspects of the motion sensor 415 and/or ranging active reflected wave detector 420 and/or camera 425 could be provided by a processor that also provides the CPU 405, and resources of the processor could be shared to provide the functions of the CPU 405 and the processing aspects motion sensor 415 and/or ranging active reflected wave detector 420 and/or camera 425. Similarly, functions of the CPU 405, such as those described herein, could be performed in the motion sensor 415 and/or the ranging active reflected wave detector 420 and/or the camera 425.

The ranging active reflected wave detector 420 operates to emit electromagnetic waves into the region and to measure wave reflections of those emitted waves that have been reflected by objects in the region.

The sensing device 400 further comprises a communications interface 435 for interfacing with at least one of: a local hub (not shown), other sensing devices 400, and/or directly with a remote server, depending on the particular configuration of the sensing device 400. In this way, data can be transferred, control instructions can be sent and/or received, and/or processing performed locally, remotely or according to any suitable distributed processing scheme. The communications interface 435 can be configured for one or both of: wired and/or wireless communication.

As shown in FIG. 4, a housing 430 of the sensing device 400 houses the motion sensor 415, the ranging active reflected wave detector 420 and the camera 425. Alternatively, the motion sensor 415 could be external to the device 400 and be coupled to the CPU 405 by way of a wired or wireless connection. Similarly, the ranging active reflected wave detector 420 could be external to the device 400 and be coupled to the CPU 405 by way of a wired or wireless connection, e.g. using the communications interface 435. Similarly, the camera 425 could be external to the device 400 and be coupled to the CPU 405 by way of a wired or wireless connection. Further, the outputs of the motion sensor 415 and/or ranging active reflected wave detector 420 and/or camera 208 could be wirelessly received from/via an intermediary device that relays, manipulates and/or in part produces their outputs, for example the control hub 15, 315.

In various methods described herein the ranging active reflected wave detector 420 monitors a region and determines a location of a person in the region. Optionally, the detected triggering event configures the ranging active reflected wave detector 420 to capture measurements and/or configures the CPU or ranging active reflected wave detector 420 to the track objects suspected of being human, based on measurements captured by the ranging active reflected wave detector 420.

In embodiments, the CPU 405 is optionally configured to detect motion in the environment based on an output of the motion sensor 415. In some examples, detection of motion in the environment immediately after a period where no motion has been detected for at least a threshold period of time acts as the detected triggering event associated with entry into a region being monitored. The motion sensor 415 could be a passive infrared (PIR) sensor. The motion sensor 415 is preferably a PIR sensor, however it could be an active reflected wave sensor, for example radar, that detects motion based on the Doppler effect, which may optionally be provided by the ranging active reflected wave detector 420. For example, the motion sensor 415 could be a radar-based motion sensor which detects motion based on the Doppler component of a radar signal. The motion sensor 415 is configured to detect motion in a motion detection monitoring region in the environment. The lateral field of view of the motion sensor 415 could be between 100° and 120°. It will be appreciated that this angle range is merely an example, the lateral field of view of the motion sensor 415 could be up to 160° or higher. The motion detection monitoring region may be bound by a minimum detection range of the motion sensor 415 and a maximum detection range of the motion sensor 415. If an object is moving beyond the maximum detection range of the motion sensor 415, the motion sensor 415 will not detect this movement, or at least not as reliably (e.g. the motion sensor 415 won't meet its performance specifications). Similarly, if an object is moving between the motion sensor 415 and the minimum detection range of the motion sensor 415, the motion sensor 415 will not detect this movement, or at least not as reliably.

The ranging active reflected wave detector 420 operates in accordance with one of various reflected wave technologies. In operation, the CPU 405 uses the output of the ranging active reflected wave detector 420 to determine the presence of a target object (e.g. human). The lateral field of view of the ranging active reflected wave detector 420 could have a field of view of 160°, for example.

In these examples, the ranging active reflected wave detector 420 is a ranging detector. That is, in contrast with Doppler-only detectors, the ranging active reflected wave detector 420 is configured to determine the location of any object (e.g. a person) in its field of view in three dimensions. This enables the CPU 405 to track the location of an object in the environment. The ranging active reflected wave detector 420 is also configured to correlate the location of the objects with time, so that the location of the object (e.g. human) can be determined for a given time.

In some implementations, the ranging active reflected wave detector 420 provides both a ranging-based output and a Doppler-based output based on measuring wave reflections from the environment. In these implementations, the ranging active reflected wave detector 420 is configured to detect motion in a motion detection monitoring region in the environment, and a dedicated motion sensor 415 is not required. In some examples, detection of motion by the ranging active reflected wave detector 420 in the environment immediately after a period where no motion has been detected for at least a threshold period of time could act as the detected triggering event associated with entry into a region being monitored.

Preferably, the ranging active reflected wave detector 420 is a radar sensor. The radar sensor could use millimeter wave (mmWave) sensing technology. The radar is, in some embodiments, a continuous-wave radar, such as frequency modulated continuous wave (FMCW) technology. Such a chip with such technology may be, for example, Texas Instruments Inc. part number iwr6843 or iwr16432. The radar generally operates in microwave frequencies, e.g. in some embodiments a carrier wave in the range of 1-100 GHz (76-81 Ghz or 57-64 GHz in some embodiments), and/or radio waves in the 300 MHz to 300 GHz range, and/or millimeter waves in the 30 GHz to 300 GHz range. In some embodiments, the radar has a bandwidth of at least 1 GHz. The ranging active reflected wave detector 420 may comprise antennas for both emitting waves and for receiving reflections of the emitted waves, and in some embodiment different antennas may be used for the emitting compared with the receiving.

The ranging active reflected wave detector 420 is also associated with a monitoring region, such as a “radar monitoring region”. The monitoring region is the region in the environment that the active reflected wave detector 206 observes, when installed and operational. It is what the ranging active reflected wave detector 420 can “see” and may therefore be alternatively termed “observing region”. The radar monitoring region, for example, defines the region in which objects are detectable by the radar. The monitoring by the ranging active reflected wave detector 420 (e.g. a radar) could be, or include, any one or more of observing, checking, or keeping a continuous record of reflective wave measurements (e.g. radar measurements). Further, there could be different parts of the radar monitoring region that are monitored in respectively different ways. For example, it may be that reflective wave measurements (e.g. radar measurements) are performed and tested against a certain condition for one part of the radar monitoring region, such as a region of interest, whereas reflective wave measurements (e.g. radar measurements) for another part of the radar monitoring region, such as the remaining area outside the region of interest, may merely be performed but then disregarded. The disregarding of such measurements could be because they are outside the region of interest. For example, the monitoring could comprise generating reflective wave measurements (e.g. radar measurements) for all of the radar monitoring region and subsequently reducing the set of measurements to be confined to a smaller area that is under surveillance. Thus, the region observed by the ranging active reflected wave detector can optionally be smaller than a larger region from which measurements are collectable by the ranging active reflected wave detector.

The radar monitoring region is bound by the minimum detection range of the ranging active reflected wave detector 420 and the maximum detection range of the ranging active reflected wave detector 420. If an object is present beyond the maximum detection range of the ranging active reflected wave detector 420, the ranging active reflected wave detector 420 will not detect the object. For example, the maximum detection range of the ranging active reflected wave detector 420 may depend on the type of object (for example its scattering cross section, e.g. radar cross section in the case of radar). Similarly, if an object is present between the ranging active reflected wave detector 420 and the minimum detection range of the ranging active reflected wave detector 420, the ranging active reflected wave detector 420 will not detect the object.

A user is also able to define one or more “radar region of interest” associated with the ranging active reflected wave detector 420. A radar region of interest is, or is within, the radar monitoring region and is defined as a region that causes a certain action to be taken. This action that is performed could be that the object detected in the radar region of interest is tracked. In some examples, the radar region of interest corresponds to a region defined by a virtual fence within the field of view of the ranging active reflected wave detector 420. During installation of the sensing device 400, the installer will switch the sensing device 400 to a calibration or configuration mode for the defining of the virtual fence. Exemplary methods for an installer to define such a virtual fence is described in International patent application number PCT/IL2020/050130, filed 4 Feb. 2020, the contents of which are incorporated herein by reference in their entirety. However, other methods of defining a virtual fence could alternatively be employed. It will be appreciated that more than one virtual fence could be defined within the field of view of the ranging active reflected wave detector 420. The region of interest would generally be defined on a case-by-case basis at installation, depending on the use case, e.g. the environment in which it is installed.

As will be appreciated the ranging active reflected wave detector 420 is an “active” detector in the sense of it relying on delivery of waves from an integrated source in order to receive reflections of the waves emitted by it. The ranging active reflected wave detector 420 is not limited to being a radar sensor, and in other embodiments alternative ranging detectors could be used, for example the ranging active reflected wave detector 420 could be a LIDAR sensor, or a sonar sensor.

Thus, whilst we refer herein to a “radar region of interest” and a “radar monitoring region” such terms may more generally be substituted with “region of interest of the active reflected wave detector” and “monitoring region of the active reflected wave detector”, respectively.

The ranging active reflected wave detector 420 being a radar sensor is advantageous over other reflected wave technologies in that radar signals can transmit through some materials, e.g. wood or plastic, but not others-notably water which is important because humans are mostly water. This means that the radar can potentially “see” a person in the environment even if they are behind an object of a radar-transmissive material. Depending on the material, this may not be the case for sonar or LIDAR.

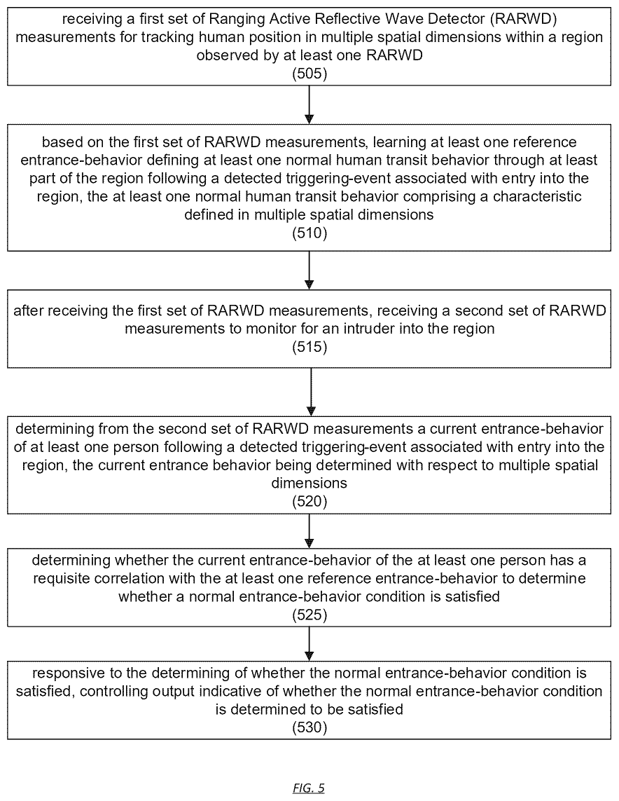

FIG. 5 is a flowchart illustrating a computer-implemented method of monitoring a region to detect an intruder, which could be carried out using the systems 5, 205, 305 of any of FIGS. 1 to 3, and/or which could be carried out using the device 400 of FIG. 4. Given that the method can be performed by any of the systems 5, 205, 305 of FIGS. 1 to 3, or by other systems having different arrangements, performance of the method can be performed by a processor of any, some or all of: one or more or each of the sensing devices 10a-10d, 210a-210d, 310a-310f, the local control hub 15, 315, the remote server 20, 220, 320 or by a different computing resource. That is, the method could be performed entirely on any of the devices or systems listed above, or distributed over some or all of the devices listed above, in which one or more steps of the method given could be performed by a different device to at least one other of the steps, with any data required to perform the step being communicated between devices. At 505, the method comprises receiving a first set of Ranging Active Reflective Wave Detector (RARWD) measurements for tracking human position in multiple spatial dimensions within a region observed by at least one RARWD. For example, the first set of RARWD measurements could be collected using the device 400 or the sensing device 10a, 10b, 210a, 210b, 310c, 310d, 310e that comprises the RARWD in the systems 5, 205, 305 of any of FIG. 1, 2 or 3. In some examples, the first set of RARWD measurements are collected during a defined learning period, such as but not limited to a set-up period or a learning period selected by a user or installer or the like.

The first set of RARWD measurements could be, but need not, be collected in a single session. For example, the first set of RARWD measurements could optionally comprise a plurality of subsets of RARWD measurements, wherein each subset of RARWD measurements is for a different period of time. That is, the first set of RARWD measurements could be collected during a single session or single operation of the RARWD sensing device 10a, 10b, 210a, 210b, 310c, 310d, 310e, 400 or could be collected over multiple different sessions or operations of the RARWD sensing device 10a, 10b, 210a, 210b, 310c, 310d, 310e, 400.

Similarly, each of the measurements in the first set or RARWD measurements could be observed by the same RARWD sensing device 10a, 10b, 210a, 210b, 310c, 310d, 310e, 400 or the first set of RARWD measurements may be measurements observed by a plurality of the RARWD sensing devices 10a, 10b, 210a, 210b, 310c, 310d, 310e, 400, i.e. at least one RARWD measurement of the first set of RARWD measurements could be observed by a different RARWD sensing device 10a, 10b, 210a, 210b, 310c, 310d, 310e, 400 to the RARWD sensing device 10a, 10b, 210a, 210b, 310c, 310d, 310e, 400 that observes at least one other of the first set of RARWD measurements.

In examples, the local control hub 15, 315 can send instructions to at least one of the RARWD sensing devices 10a, 10b, 210a, 210b, 310c, 310d, 310e, 400 to emit waves (e.g. electromagnetic waves such as radio waves or microwaves) to measure the first set of RARWD measurements based on the reflections of the emitted waves received by the at least one of the RARWD sensing devices 10a, 10b, 210a, 210b, 310c, 310d, 310e, 400. The measurements are ranging measurements including at least a range to any reflecting objects and a bearing to any reflecting objects, and are time correlated so that a three-dimension position of any reflecting object (such as a human) represented in the first set of RARWD measurements can be determined for a given moment in time.

At 510, based on the first set of RARWD measurements, at least one reference entrance-behaviour defining at least one normal human transit behaviour through at least part of the region following a detected triggering-event associated with entry into the region is learned. The at least one normal human transit behaviour comprises a characteristic defined in multiple spatial dimensions.

The at least one normal human transit behaviour is representative of a usual or normal behaviour of humans after entering the region. For example, this could include one or more or any of: a pathway through at least part of the region that is normally traversed by humans after entering the region, a travel-path normally taken by a person after entering the region, a pause at a specific location and/or time after entering the religion, passing through one or more locations, and/or the like. Specifically, each of the at least one normal human transit behaviours represents any human transit behaviour that is detected as occurring during the set-up or learning period. Thus, the term “normal” in the phrase “normal human transit behaviour” should not be taken as requiring any particular frequency of regularity of occurring. For example, while the system may learn what is normal from numerous instances of entries, it may also be shown what is normal by a person or group or people consciously demonstrating in a single instance what is normal. Learning from numerous instances of entries may employ any suitable learning algorithm as would be known by the person skilled in the art when presented with the present disclosure.

Each of the at least one normal human transit behaviours represents a human transit behaviour being performed one or more times, wherein each of the one or more times follows respective instances of a triggering event associated with entry into the region. Where a normal human transit behaviour represents a human transit behaviour being performed more than one time, the reference entrance-behaviour corresponds to a representative average or other combination or function of the human transit behaviour being performed more than one times.

The normal human transit-behaviour is associated with a specific time, duration or time range, e.g. traversing from a location to another location in a specific time or time-range. As such, the at least one reference entrance-behaviour could further define at least one duration of time associated with performance of the at least one normal human transit behaviour. For example, the performance of a given normal human transit behaviour, or of a part of the normal human transit behaviour, could optionally last a given duration of time.

Each of the at least one reference entrance-behaviours comprises or consists of one or more aspects of behaviour. For example, the one or more aspects of behaviour could comprise one or more of: arriving at a first milestone location associated with a first milestone event; arriving at second milestone location associated with a second milestone event, the second milestone being different to the first milestone; traversing at least part of the region according to a travel-path; and/or traversing at least part of the region through a pathway.

In examples, each milestone has an associated duration of time, e.g. a duration of time during which a person traversing the region should arrive at the milestone. The milestones can be independent, i.e. there can be a requirement to reach any of the milestones in a duration of time, or the milestones can be sequential, i.e. the normal human transit-behaviour could comprise arriving at milestones of a plurality of milestones in a specific order, the arrival at each milestone having to be within a duration of time associated with that specific milestone. Each milestone could be associated with a milestone event. For example, the milestone event could comprise a person pausing or changing direction, and the location at which the milestone event occurs could be taken as the milestone location and the milestone time for that milestone could be based on a time (e.g. a time relative to a previous milestone or entrance into the region) at which the milestone event occurs. The possible milestone events are not limited to pausing or changing direction and could include any of: human travel of a predefined distance since being at a defined previous location, e.g. a location of entering the region; human travel of a predefined displacement from a defined previous location (such as a previous milestone location or location of entry into the region); a predefined amount of time having passed since a human entered the region or since a triggering event; changing speed of movement in a predetermined manner by a human, after commencing a transit through at least part of the region; and changing direction of movement in a predetermined manner by a human after commencing a transit through at least part of the region, for example.

Defining the reference entrance-behaviour in terms of milestones to be met, requires the person to be at the milestone locations within a time frame associated with the associated milestone time, but optionally does not require the person to take any specific travel path between milestones.

Alternatively, or additionally to the use of milestones, the at least one reference-entrance-behaviour could comprise traversing at least part of the region according to a travel-path and/or along a pathway. The travel-path or pathway is defined in multiple spatial dimensions, e.g. in 2D or 3D and extends from a first location to a second location. Typically, the first location will be a location at which a human is first detected in the first set of RARWD measurements. The human is first detected in the first set of RARWD measurements if the human is detected after an away period in which the region is determined to be vacant, optionally determined to be vacant for at least a minimum amount of time, e.g. 30 seconds or 1 minute. The at least one reference-entrance-behaviour comprises traversing at least part of the region according to the travel-path.

The pathway is defined based on one or more travel-paths undertaken by a person in a reference entrance-behaviour of the at least one reference entrance-behaviours. The pathway has lateral boundaries that laterally surround all of the one or more travel-paths in the reference entrance-behaviour such that the lateral boundaries of the pathway effectively form a corridor around the one or more travel-paths to thereby form the pathway. The lateral boundaries could comprise set or pre-set distances from a representative average or could be a function of the one or more travel-paths or from outermost parts of the one or more travel-paths. For example, an extent of the lateral boundaries could be dependent on, e.g. set to be a function of, the one or more travel-paths such as a spread, variation or spatial distribution of the one or more travel paths, e.g. with a greater spread or spatial variation of travel-paths of the one or more travel-paths giving rise to a greater lateral extent of the lateral boundaries than when there is less spread or spatial variation of travel-paths of the one or more travel-paths.

Where the one or more travel-paths comprises multiple travel-paths, the multiple travel-paths can be determined to represent a single reference entrance-behaviour, and optionally grouped into the same pathway, based on the multiple travel-paths having a predetermined correlation with each other. For example, if a particular set of travel-paths are at least one or all of: a similar shape, have similar path lengths, and/or commence and end at similar locations, they are determined to represent a single reference entrance-behaviour and optionally grouped into the same pathway.

In some optional examples, the at least one reference entrance-behaviour is also dependent on contextual conditions, wherein the current entrance-behaviour occurs under said contextual conditions. The context conditions could come from data from the one or more sensing devices, metadata, system data, other data sources or databases, and/or the like. In an example, the reference entrance-behaviour is dependent on an occupancy, or lack thereof, prior to the reference entrance-behaviour and prior to the current entrance-behaviour. In additional or alternative examples, the reference entrance-behaviours are dependent on a time of entry into the region, e.g. time of day. For example, people can take different travel paths through the region after entering the region at different times of day. For example, parents entering at night might normally proceed to their children's bedrooms to check on them but not do so during the day when the children are at school. In such cases, the method optionally comprises only making comparisons with those reference entrance-behaviours that are suitable for the current time of day.

The triggering event can be an event indicative of entrance or other appearance of a person into the region. However, the triggering events are not limited to this, and other triggering events could be used, such as occurrence of a preceding or other event in a plurality or series of events. In examples, the triggering event comprises an indication of an actual or likely human-entry event, i.e. an event associated with or indicative of entry of a human into the region being monitored from outwith the region being monitored. In this context, the region being monitored may be the active reflected wave detector monitoring region or a region of interest within it.

In some examples, the human-entry event is limited to occasions in which the region was unoccupied, i.e. vacant, prior to the object-entry event. In this case, it can be determined if the region is vacant of humans prior to the entry into the region Whether the region is vacant can be determined, for example, using the at least one of the RARWD sensing devices 10a, 10b, 210a, 210b, 310c, 310d, 310e, 400 to determine when the region is vacant of humans prior to the entry into the region, or it could be determined using one of the other sensing devices such as the motion sensor 10c, 210c, 310a. Examples of suitable human-entry events include at least one or any of: a full or partial disarming of a security system associated with the region; a detected change in a door state of a door associated with the region, e.g. using one of the window or door state sensors 10d, 210d, 310b, 310f; a detected passage of a person through an entry associated with the region or a physically partitioned portion therein (e.g. a room, where the region includes more than the room), e.g. using a curtain PIR detector, etc., or using a force or pressure sensor on or in a flooring, etc.; a detected passage of a person into the region, e.g. using a directional curtain PIR detector, or a barrier detector based on beam interruption, etc.; a detected presence or motion at an entry location at which the region is entered, e.g. by a motion sensor (such as motion sensor 10c, 210c, 310a) or presence sensor positioned to monitor the entry; and/or a moment at which an object is detected as entering the region based on RARWD measurements.

The door associated with the region is a door for entering the region or a physically partitioned part thereof and the detected change in door state comprises a detecting door-opening event, e.g. using the door state sensor 10d, 210d, 310b or 310f.

Detection of any human-entry event could constitute a triggering-event, e.g. if there are a door sensor and an entry passage detector present, then both have the ability to trigger the same human-entry event. That is, the system 5, 205, 305 need not necessarily distinguish between the different ways in which the person may enter, though in some examples the system 5, 205, 305 could do this.

In this way, during the set-up, learning or other period during which the first set of RARWD measurements are collected, normal human transit behaviour through at least part of the region following a detected triggering-event associated with entry into the region is identified from the first set of RARWD measurements, from which the range and bearing and thereby the location of the human at given times can be determined. The at least one reference entrance-behaviour can then be learned from the at least one normal human transit behaviour.

At 515, after receiving the first set of RARWD measurements, a second set of RARWD measurements to monitor for an intruder into the region are received.

The at least one RARWD sensing device 10a, 10b, 210a, 210b, 310c-e, 420 may be configured to capture the second set of RAWD measurements only once the learning period has completed, e.g. during a measurement or operating period. This typically involves instructing the at least one RARWD sensing device 10a, 10b, 210a, 210b, 310c-e, 420 to emit waves (e.g. electromagnetic waves such as radio or micro waves) to measure the second set of RARWD measurements. Optionally, the second set of RARWD measurements are observed by the same at least one RARWD sensing device 10a, 10b, 210a, 210b, 310c-e, 420 as the first set of measurements. However, this need not be the case and in other examples, the second set of RARWD measurements are observed by at least one different RARWD sensing device 10a, 10b, 210a, 210b, 310c-e, 420 to the at least one RARWD sensing device 10a, 10b, 210a, 210b, 310c-e, 420 used to collect the first set of RARWD measurements. In examples, the at least one RARWD sensing device 10a, 10b, 210a, 210b, 310c-e, 420 used to collect the second set or RARWD measurements consists of a single RARWD sensing device 10a, 10b, 210a, 210b, 310c-e, 420 and in other examples the at least one RARWD sensing device 10a, 10b, 210a, 210b, 310c-e, 420 comprises a plurality of RARWD sensing devices 10a, 10b, 210a, 210b, 310c-e, 420. As discussed above in relation to the first set of RARWD measurements, the second set of RARWD measurements are indicative of ranges and bearings to objects (such as people) in the region and can be used to obtain time correlated 3D locations of any such objects.

At 520, a current entrance-behaviour of at least one person following a detected triggering-event associated with entry into the region is determined from the second set of RARWD measurements. The current entrance-behaviour is determined with respect to multiple spatial dimensions.

In some examples, the current entrance-behaviour of the least one person method comprises a spatial location (e.g. as defined by multi-dimensional, such as two or preferably three-dimensional coordinates) of the at least one person tracked over time. The tracking of the location of the at least one person over time can be determined from the second set of RARWD measurements. For example, time correlated range and bearing data extracted from the second set of RARWD measurements can be used to determine the location of the at least one person over time in three dimensions. Thus, each set of RARWD measurements may comprise an ordered set of measurements.

Optionally, a plurality of people can be tracked simultaneously to derive respective current entrance-behaviours of different people. The tracking of the plurality of people comprises determining spatial locations (e.g. 3D coordinates) of the plurality of people over time from the second set of RARWD measurements.

Optionally, the detected triggering-event that is followed by the current entrance-behaviour and the detected triggering-event that is followed by the at least one normal human transit behaviour is required to be sensed by a same sensing device 10, 210, 310, 400, 415 or any sensing device 10, 210, 310, 400, 415 of a same set sensing devices 10, 210, 310, 400, 415. The sensing devices 10, 210, 310, 400, 415 used to detect the triggering-event could be set up to sense entry into the region from one particular location only. As examples, the sensing device used to detect the triggering-event could be the door or window state sensors 10d, 210d, 310b, 310f or motion sensors 10c, 210c, 310a, particularly when the motion sensors are curtain sensors configured to detect motion in a narrow zone across an entrance into the region.

At 525, it is determined whether the current entrance-behaviour of the at least one person has a requisite correlation with the at least one reference entrance-behaviour to determine whether a normal entrance-behaviour condition is satisfied. If there are a plurality of people being tracked, then this could comprise determining if the current entrance-behaviour of any or all of the plurality of people have the requisite correlation with the at least one reference entrance-behaviour. For example, this could comprise determining whether the current entrance-behaviour of every person has a requisite correlation with any reference entrance-behaviour of the least one reference entrance-behaviours. In examples where there are multiple reference entrance-behaviours, the requisite correlation can be with any reference entrance-behaviour or with a particular reference entrance-behaviour for that person.

For examples in which the reference entrance-behaviour comprises one or more milestones having an associated milestone location and an associated milestone time, then determining whether the current entrance-behaviour of the at least one person has a requisite correlation with the at least one reference entrance-behaviour comprises determining whether the current entrance-behaviour of the at least one person comprises the at least one person arriving at or within a predefined proximity to the first milestone location within a first duration of time based on the associated milestone time, regardless of the route taken between milestones (unless a travel path or pathway is also comprised in the at least one of the reference entrance-behaviours).

For examples in which the at least one reference-entrance-behaviour comprises traversing at least part of the region according to a travel-path, then determining whether the current entrance-behaviour of the at least one person has a requisite correlation with the at least one reference entrance-behaviour comprises determining whether the current entrance-behaviour comprises traversing at least part of the region according to a current travel-path that has a requisite consistency with a travel-path in the at least one reference entrance-behaviour.

Whether the current entrance-behaviour of the at least one person has a requisite correlation with the at least one reference entrance-behaviour could depend on any of a range of criteria.

As an example, the requisite consistency could comprise the current travel-path having a current path length that has a minimum correlation with a reference path length of said travel-path in the at least one reference entrance-behaviour. In an alternative or additional example, the requisite consistency could include the current travel-path having a start location and an end location that are the same or within a predefined maximum distance of a respective start location and end location of said travel-path in the at least one reference entrance-behaviour. According to another alternative or additional example, the requisite consistency includes the current travel-path having directional consistency with said travel-path in the at least one reference entrance-behaviour. In examples, any or all of the above or any combinations thereof, could be used for determining whether the current entrance-behaviour of the at least one person has a requisite correlation with the at least one reference entrance-behaviour. The minimum correlation requirement, could, for example, include at least a minimum threshold correlation, such as at least one or each of: the current path length being within at least a threshold closeness to the reference path length, the start location and an end location of the current travel-path being the same or within a predefined maximum distance of a respective start location and end location of said travel-path in the at least one reference entrance-behaviour, and/or the current travel-path and said travel-path commencing in the same direction or having directions after a certain traversed distance and/or traversal time that are within a predefined variation limit, e.g. within 20 degrees. However, the above are provided as examples, and other approaches could be used.

As indicated above, in some examples, the at least one reference-entrance-behaviour comprises traversing at least part of the region through a pathway from a first location to a second location. In these examples, the current entrance-behaviour of the at least one person has the requisite correlation with the at least one reference entrance-behaviour if, according to the second set of RARWD measurements, the at least one person traverses from the first location to the second location without straying from the pathway, i.e. whilst remaining within the lateral boundaries of the reference pathway along at least a threshold amount or all of the reference pathway.

Where the at least one person comprises a plurality of people, determining whether the at least one person has a current travel-path that remains within a reference pathway could comprise determining that all of the plurality of people remain within a same reference pathway or within any of a plurality of different reference pathways.

In examples in which the reference-behaviours are dependent on contextual conditions, the determining of whether the current entrance-behaviour of the at least one person has a requisite correlation with the at least one reference entrance-behaviour comprises determining whether the current entrance-behaviour of the at least one person has a requisite correlation with at least one reference entrance-behaviour that matches the contextual conditions and/or time of entry of the current entrance-behaviour of the at least one person. For example, it can be determined whether the current entrance-behaviour of the at least one person has a requisite correlation with the at least one reference entrance-behaviour having the current time of day or having a time within a time threshold of the current time.

Regardless of which of the above approaches is used, i.e. whether it is a correlation with milestones, or one or more travel-paths or with one or more reference pathways or with some other condition that is used to determine whether the current entrance-behaviour of the at least one person has a requisite correlation with the at least one reference entrance-behaviour, a determination of a normal entrance-behaviours being satisfied is dependent on the current entrance-behaviour of the at least one person having the requisite correlation with the at least one reference entrance-behaviour.

At 530, the method comprises generating an output for indicating whether a normal entrance-behaviour condition is determined to be satisfied. If the entrance-behaviour condition is determined not to be satisfied, then this could be indicative of an intruder and the output could form at least part of a logic for triggering an intruder related action, such as but not limited to at least one of: performing a verification action, raising an alarm, sending an electronic notification to a registered user or monitoring station, deploying a deterrent, and/or the like.

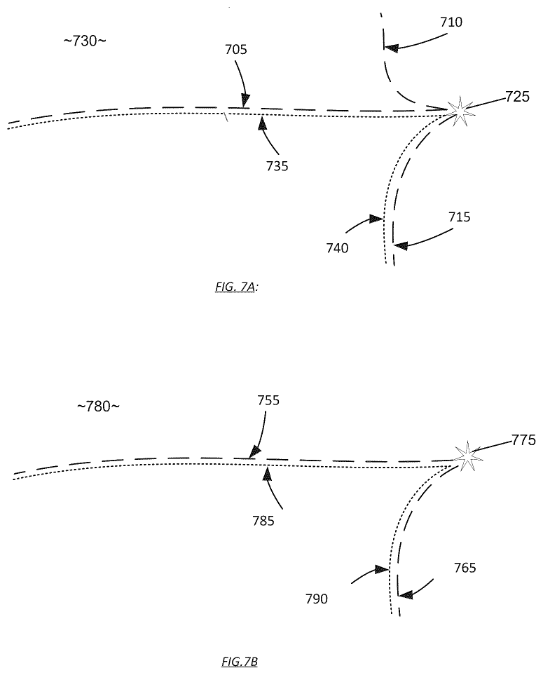

The method given above includes a number of options, such as different examples of at least one reference entrance-behaviour, current entrance-behaviour and for determining whether the current entrance-behaviour of the at least one person has a requisite correlation with the at least one reference entrance-behaviour. Some of these options are discussed below in relation to FIGS. 7A to 18.

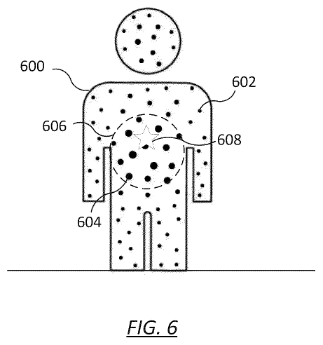

FIG. 6 illustrates a map of reflections. The size of the point represents the intensity (magnitude) of energy level of the radar reflections (see larger point 604). Different parts or portions of the body reflect the emitted signal (e.g. radar) differently. For example, generally, reflections from areas of the torso 606 are stronger than reflections from the limbs. Each point represents coordinates within a bounding shape for each portion of the body. Each portion can be separately considered and have separate boundaries, e.g. the torso and the head may be designated as different portions. The point cloud can be used as the basis for a calculation of a reference parameter or set of parameters which can be stored instead of or in conjunction with the point cloud data for a reference object (human) for comparison with a parameter or set of parameters derived or calculated from a point cloud for radar detections from an object (human).

When a cluster of measurement points 602, 604 are received from an object in the environment, a location of a particular part/point on the object or a portion of the object, e.g. its centre, may be determined from the cluster of measurement point positions having regard to the intensity or magnitude of the reflections (e.g. a centre location comprising an average of the locations of the reflections weighted by their intensity or magnitude). As illustrated in FIG. 6, the reference body 600 has a point cloud from which its centre has been calculated and represented by the location 608, represented by the star shape. In this embodiment, the torso 606 of the body 600 is separately identified from the body 600 and the centre of that portion of the body is indicated. In alternative embodiments, the body 600 can be treated as a whole or a centre can be determined for each of more than one body part e.g. the torso 606 and the head, for separate comparisons with centres of corresponding portions of a scanned body 600.

In one or more embodiments, the object's centre 608 or portion's centre is in some embodiments a weighted centre of the measurement points. The locations may be weighted according to a Radar Cross Section (RCS) estimate of each measurement point, where for each measurement point the RCS estimate may be calculated as a constant (which may be determined empirically for the RARWD sensing device 10a, 10b, 210a, 210b, 310c, 310d, 310e, 400) multiplied by the signal to noise ratio for the measurement divided by R⁴, where R is the distance from the RARWD sensing device 10a, 10b, 210a, 210b, 310c, 310d, 310e, 400 antenna configuration to the position corresponding to the measurement point. In other embodiments, the RCS may be calculated as a constant multiplied by the signal for the measurement divided by R⁴. This may be the case, for example, if the noise is constant or may be treated as though it were constant. Regardless, the received radar reflections in the exemplary embodiments described herein may be considered as an intensity value, such as an absolute value of the amplitude of a received radar signal.

In any case, the weighted centre, WC, of the measurement points for an object may be calculated for each dimension as:

$$W C = \frac{1}{{\sum }_{n = 1}^{N} {W}_{n}} {\sum }_{n = 1}^{N} ( {W}_{n} {P}_{n} )$$

Where:
N is the number of measurement points for the object;
Wₙ is the RCS estimate for the n^{th} measurement point; and
Pₙ is the location (e.g. its coordinate) for the n^{th} measurement point in that dimension.

The region for which the RARWD sensing devices 10a, 10b, 210a, 210b, 310c, 310d, 310e, 400 are capable of identifying reflections of waves emitted from the RARWD sensing devices 10a, 10b, 210a, 210b, 310c, 310d, 310e, 400 is one possible way to define an observable region that is observable by the RARWD sensing devices 10a, 10b, 210a, 210b, 310c, 310d, 310e, 400. This is consistent with a description of the observable region being a region in the environment that the RARWD sensing devices 10a, 10b, 210a, 210b, 310c, 310d, 310e, 400 are able to observe, when in position for use and operational in that position, and may be defined by distance limitations (e.g. the maximum distance that is observable by the radar) and its field of view. Optionally the observable region may be software configurable one or both of: on installation and/or during use.

FIG. 7A illustrates an example in which the current entrance-behaviour associated with each person of the one or more people entering a region represented in the second set of RARWD measurements must have a requisite correlation with any reference entrance-behaviour of the at least one reference entrance-behaviours for the normal-entrance-behaviour condition to be satisfied. That is, every present person, whether that be one person or a plurality of people, must behave with a requisite correlation with a reference entrance-behaviour in order for the normal entrance-behaviour condition to be satisfied.

The example of FIG. 7A is agnostic to which reference entrance-behaviour a person exhibits. As such, in cases where there are multiple reference entrance-behaviours, the requisite correlation could be with any reference entrance-behaviour.

The specific example of FIG. 7A has three reference entrance-behaviours. By way of example, each reference entrance-behaviour is shown as comprising a travel path 705, 715, 720 normally taken by humans following a detected triggering-event 725 associated with entry into a region 730, but this need not be the case. In this example, the second set of RARWD measurements represents two people entering the region 730 at substantially the same time (e.g. within a predefined time window). The second set of RARWD measurements could be collected, for example, by at least one of the sensing devices 10a, 10b, 210a, 210b, 310c, 310d, 310e, 420 shown in any of FIGS. 1 to 4. Each of the two people takes a different travel path 735, 740 through the region after the triggering-event 725 associated with entry into the region 730. In this case, the travel path 735 taken by a first of the two people is determined to have a requisite correlation with the reference travel path 705 of one of the reference entrance-behaviours. For example, the requisite correlation could include one or more of: having first and second locations that are within a threshold distance of each other, path length correlation, path shape correlation and/or directional correlation representing a correlation in direction of travel and/or the like. Similarly, the travel path 740 taken by a second of the two people is determined to have a requisite correlation with a different reference travel path 615 of one of the reference entrance-behaviours. In this case, since the current entrance-behaviour associated with every person of entering the region 730 after a triggering-event 625 has the requisite correlation with a reference behaviour 705, 715 of the at least one reference entrance-behaviour 705, 710, 715, the normal-entrance-behaviour condition is determined to be satisfied.

FIG. 7B illustrates an example in which the current entrance-behaviour associated with each person of the one or more people entering a region represented in the second set of RARWD measurements must have a requisite correlation with a specific reference behaviour of the at least one reference entrance-behaviours for that person for the normal-entrance-behaviour condition to be satisfied. That is, every present person, whether that be one person or a plurality of people, must behave with a requisite correlation with a specific reference entrance-behaviour in order for the normal entrance-behaviour condition to be satisfied, which could be a specific reference behaviour for that person.

The example of FIG. 7B each person is associated with a specific reference entrance-behaviour. In this case, a first person is associated with a first reference entrance-behaviour in the form of travel path 755 and a second person is associated with a second reference entrance-behaviour in the form of travel path 765, the first and second person entering at substantially the same time (e.g. within a predefined time window). However, in other examples, one or more milestones, a reference pathway or another form of reference entrance-behaviour could be used. According to the second set of RARWD measurements, the first person's current entrance-behaviour in the form of travel path 785 through the region after the triggering-event 775 associated with entry into the region 780 has the necessary correlation with the first reference entrance-behaviour 755 and the second person's current entrance-behaviour in the form of travel path 790 through the region after the triggering-event 775 associated with entry into the region 780 has the necessary correlation with the second reference entrance-behaviour 765. As such, in the example of FIG. 7B, the normal-entrance-behaviour condition is determined to be satisfied. However, if for example, the first person's travel path 785 instead had the requisite correlation with a different reference entrance-behaviour 765 that is not associated with that person, then the normal-entrance-behaviour condition would not be satisfied, unlike in the example of FIG. 7A.

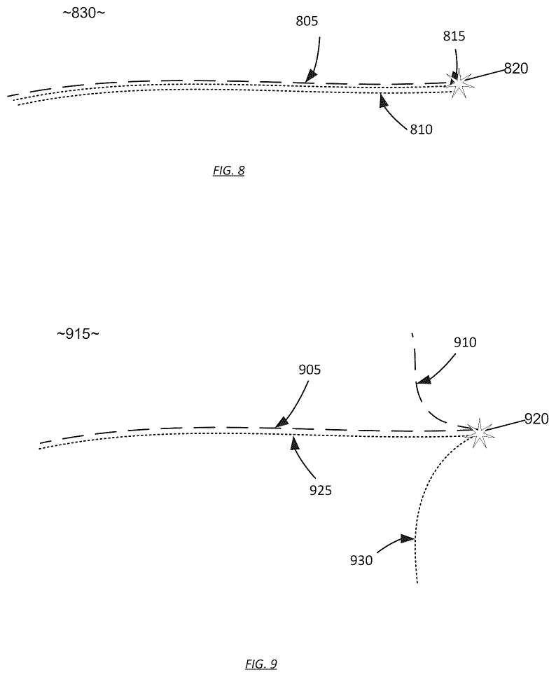

FIG. 8 illustrates another example, in which the current entrance-behaviour of every person entering the region is assessed against the same reference entrance-behaviour, and the current entrance-behaviour of every person entering the region must have the requisite correlation with the same reference entrance-behaviour in order for the normal-entrance-behaviour condition to be satisfied.

In this example, there is a single common reference entrance-behaviour in the form of reference travel path 805, and the current entrance-behaviour in the form of a travel path for both a first person (travel path 810) and a substantially simultaneously entering second person (travel path 815) through the region after the triggering-event 820 associated with entry into the region 830 both have the necessary correlation with the common reference travel path 805. As such, in the example of FIG. 8, the normal-entrance-behaviour condition is determined to be satisfied. However, if either the first person's travel path 810 or the second person's travel path 815 did not have the requisite correlation with the common reference entrance-behaviour 805, then the normal-entrance-behaviour condition would not be satisfied.

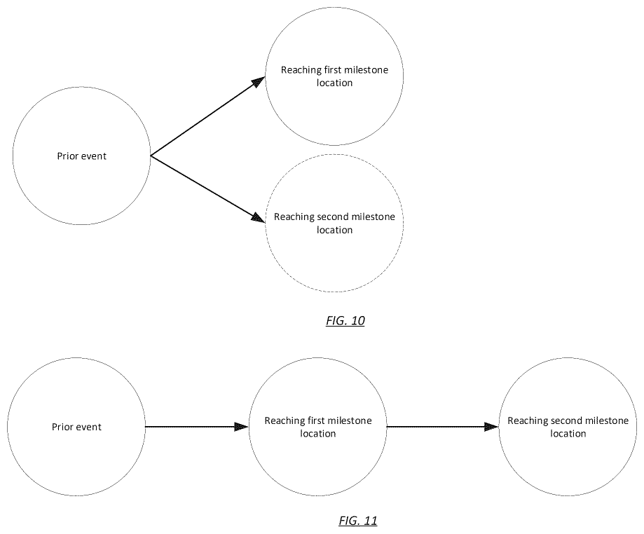

FIG. 9 illustrates an example in which the at least one person can be a subset of all the people that enter the region. That is, only a subset of the at least one people that enter the region need have the requisite correlation with at least one of the reference entrance-behaviours in order for the normal entrance-behaviour condition to be satisfied. The subset can be any suitable number of the people, e.g. one or more people, and more specifically one person in some embodiments.

In the specific example of FIG. 9, there are two reference entrance-behaviours in the form of respective reference pathways 905, 910 that represent the normal human transit behaviour through at least part of a region 915 following a detected triggering-event 920 associated with entry into the region 915. In this example, the second set of RARWD measurements is representative of travel-paths 925, 930 respectively taken by two people, substantially simultaneously, through the region 915. One of the travel paths 925 has the requisite correlation with a travel path of one of the reference pathways 905, 910 but the other of the travel paths taken by the other person does not. In the examples of FIGS. 6 to 8, a travel path of a person through the region without a requisite correlation with the pathway of one of the reference entrance-behaviours would result in the normal entrance-behaviour condition not being satisfied. However, the example of FIG. 9 only requires a subset of the people to have the requisite correlation, and in the example of FIG. 9, the subset only requires a single person to have the requisite correlation with the pathway of one of the reference entrance-behaviours, such that in the example of FIG. 9, the normal entrance-behaviour condition is satisfied.

Whilst FIGS. 6 to 9 show examples of reference entrance-behaviours and current behaviours in the form of travel paths, other forms of reference entrance-behaviours and current behaviours could be used, such as milestones or pathways.

FIGS. 10 and 11 illustrate examples that use milestones as the reference entrance-behaviour. In these examples, each of the at least one reference entrance-behaviours comprise or consist of one or more aspects of behaviour. For example, the one or more aspects of behaviour could comprise arriving at a first milestone location associated with a first milestone event and/or arriving at a second milestone location associated with a second milestone event.

Each milestone location is a location associated with a milestone event detected in the first set of RARWD measurements. The milestone events could include, for example, any of: human travel of a predefined distance since being at a defined previous location, e.g. a location of entering the region or a previous milestone location; human travel of a predefined displacement from a defined previous location, e.g. a location of entering the region or a previous milestone location; a predefined amount of time having passed since a human entered the region or since a triggering event or since a previous milestone event; changing speed of movement in a predetermined manner (optionally comprising stopping or pausing) by a human, after commencing a transit through at least part of the region; and/or changing direction of movement in a predetermined manner by a human after commencing transit through at least part of the region. The locations associated with each of these events that are represented in the first set of RARWD measurements then become the milestone locations.

In certain beneficial examples, the milestone locations are also associated with milestone time or time frames, which are associated with the occurrence of the milestone event in the first set of RARWD measurements. Time milestone time or timeframes can represent a time or time frame since a human entered the region or since a triggering event or since a previous milestone event. The milestones can be sequential, e.g. each milestone location and time must be met in chronological order in order for there to be the requisite correlation with the at least one reference entrance-behaviour and thereby the normal entrance-behaviour condition being satisfied. However, in other examples, the milestones need not be sequential, i.e. if any milestone location is met in the milestone time or time frame then there will be the requisite correlation with the at least one reference entrance-behaviour and thereby the normal entrance-behaviour condition will be satisfied.

In the case where there are milestone times or timeframes, then determining whether the current entrance-behaviour of the at least one person has a requisite correlation with the at least one reference entrance-behaviour may comprise determining whether the current entrance-behaviour comprises arriving at or within a predefined proximity to the first and/or second milestone location at the milestone time or within the milestone time frame.

FIG. 10 shows an example in which the milestone time or timeframe isn't linked to any milestone location and the current entrance-behaviour of the at least one person has a requisite correlation with the at least one reference entrance-behaviour if the at least one person represented in the second set of RARWD measurements arrives at any milestone location (i.e. the first or second milestone locations) within the milestone time or time frame since a prior event, e.g. a human entering the region or a triggering event or a previous milestone event.

Importantly, in contrast to the travel paths in FIGS. 6 to 9, for which the current travel path of the person has to have a requisite correlation with a travel path in the reference entrance-behaviour without deviating from the reference travel path by more than a certain amount, the use of milestones does not have to stipulate the travel path taken between milestones, only that the person needs to be at a specified milestone location at the milestone time or within the milestone time period in order for there to be a requisite correlation with the at least one reference entrance-behaviour.

FIG. 11 shows an example in which the reference milestone locations are sequential, i.e. each milestone location and time or time frame must be met in chronological order after the prior event for there to be the requisite correlation with the at least one reference entrance-behaviour. That is, in the example of FIG. 11, one or more of the at least one reference entrance-behaviours comprises a sequence of milestones comprising at least a first milestone location associated with a first milestone time period and a second milestone location associated with a second milestone time period, and optionally further milestone locations associated with further milestone time periods. The first milestone time period expires before the second milestone time period expires, which in turn expires before any further milestone time periods expire. As above, the prior event could be a human entering the region or a triggering event or a previous milestone event. In this case, there is a requisite correlation between the current entrance-behaviour of the at least one person and the at least one reference entrance-behaviour if the at least one person at least arrives at the first milestone location within the first milestone time period before arriving at the second milestone location within the second milestone time period. For examples having more than two milestone periods, the person would then have to arrive in order at each subsequent milestone location within the associated milestone time frame for that milestone location in order for there to be the requisite correlation between the current entrance-behaviour of the at least one person and the at least one reference entrance-behaviour.

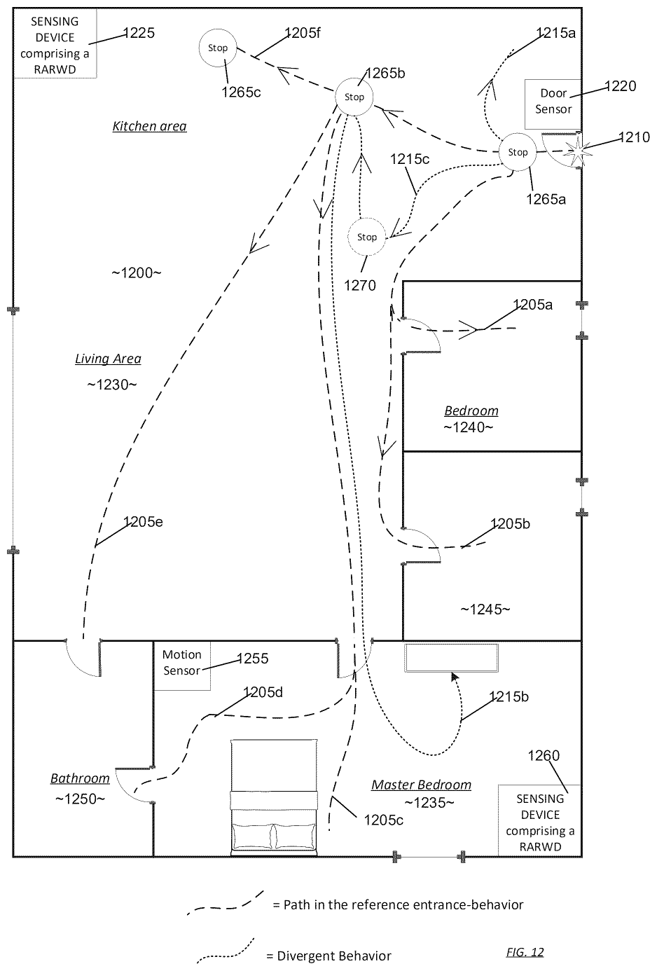

FIG. 12 illustrates an example of the use of travel paths as reference entrance-behaviour and current entrance-behaviour. That is, in this example, each reference entrance-behaviour of the at least one reference-entrance-behaviour comprises traversing at least part of a region 1200 according to a respective travel-path 1205a-f. Each travel-path 1205a-f is defined as commencing at a location 1210 at which a human is first detected in the first set of RARWD measurements, after an away period in which the region 1200 is determined to be vacant, optionally determined to be vacant for at least a minimum amount of time, e.g. 30 seconds or 1 minute.

The determining of whether the current entrance-behaviour of the at least one person has a requisite correlation with the at least one reference entrance-behaviour involves determining whether a current entrance-behaviour comprises traversing at least part of the region according to a current travel-path that has a requisite consistency with at least one of the travel-paths 1205a-f in the at least one reference entrance-behaviour. There are various possibilities for assessing whether the current entrance-behaviour comprises traversing at least part of the region according to a current travel-path that has a requisite consistency with at least one of the travel-paths 1205a-f in the at least one reference entrance-behaviour. In an example, the current entrance-behaviour has the requisite consistency with the at least one of the travel-paths 1205a-f in the at least one reference entrance-behaviour if a current path length of the current travel path has a minimum correlation with, e.g. within a threshold amount of, a path length of one of the at least one of the travel-paths 1205a-f in the at least one reference entrance-behaviour. For the avoidance of doubt, the current path length and the reference path length are each to be understood as a distance travelled (as opposed to a displacement). In another example, additionally or alternatively to the use of path length, the requisite correlation requires the current travel-path to have a start location and an end location that are the same or within a predefined maximum distance of a respective start location and end location of said reference travel-path in the at least one reference entrance-behaviour. In another example, additionally or alternatively to the use of path length and/or start and end locations, the requisite correlation requires the current travel-path to have directional consistency with said travel-path in the at least one reference entrance-behaviour. Optionally, this comprises comparing directional attributes of the current travel-path and said travel-path in the at least one reference entrance-behaviour, wherein the requisite consistency is not met if the current travel-path does not have directional consistency with said travel-path in the at least one reference entrance-behaviour. For example, there is directional inconsistency if the current travel-path and said travel-path do not both commence in the same direction, optionally identified after a minimum traversed distance and/or minimized traversal time, within a predefined variation limit, e.g. within 20 degrees.

In the specific example shown in FIG. 12, a door sensor 1220, which could be arranged in the same way as any of the door state sensors 10d, 210d, 310b, 310f of FIGS. 1, 2 and 3, is used to generate a triggering-event associated with entry of a person into the region 1200. Additionally, or alternatively, the triggering-event could be generated by a RARWD sensor 1225, which could be arranged in the same way as one of the RARWD sensing devices 10a, 210a, 310c-e or 420 of FIGS. 1 to 4. FIG. 12 shows several rooms, including an open-plan kitchen/living area 1230, a master bedroom 1235, two other bedrooms 1240, 1245, and a bathroom 1250. The door sensor 1220 monitors an open/closed state of a door into the kitchen/living area 1230 and the RARWD sensor 1225 collects ranging data to track the location of people in the kitchen/living area over time. The master bedroom 1235 is monitored by a motion sensor 1255 and a second RARWD sensing device 1260. The motion sensor 1255 could be a PIR sensor, for example, whilst the second RARWD sensing device could be arranged in the same way as any of the RARWD sensing devices 10a, 210a, 310c-e, 400 shown in any of FIGS. 1 to 4. As such, the region 1200 being monitored in this case mostly comprises the kitchen/living area 120 and the master bedroom 1235 in addition to any parts of the bathroom 1250 and bedrooms 1240, 1245 that can be observed by the sensing devices 1225, 1255, 1260.

The first and second sets of RARWD measurements referred to above in relation to FIG. 5 are collected by the RARWD sensing device 1225 and the second RARWD sensing device 1260. The normal entrance into the region is via the doorway that is monitored by the door sensor 1220 and as such this coincides with the location 1210 at which a human is first detected in the first set of RARWD measurements after a period in which the region 1200 is vacant that forms a first (start) location of each of the travel-paths of respective reference entrance-behaviours.

As indicated above, the reference entrance-behaviours represent normal human transit behaviour through at least part of the region 1200 following a detected triggering-event associated with entry into the region. In this example, the triggering event is detection of a human after at least a threshold period of the region 1200 being determined to be vacant and the triggering events occur at the location 1210 at which a human is first detected in the first set of RARWD measurements.

In the example of FIG. 12, the reference entrance-behaviours comprise both reference travel-paths 1205a-f through the region 1200 and also a plurality of milestone locations 1265a-c that correspond to milestone events in the form of a stop by a human while transiting through the region 1200. In this example, the milestones are associated with specific travel paths 1205c-1205f. If a person takes a different travel path, there may be one or more different milestones associated with that different travel path. For example, if a person is permitted to take path 1205b they do not need to meet milestones associated with the milestone locations 1265b or 1265c, but would be required to meet the milestone associated with the milestone location 1265a.

In such cases, subject to the arrangements outlined in FIGS. 6 to 9, any of which could be applied in the present example, if a current entrance-behaviour of the person represented in the second set of RARWD measurements comprises transiting through at least part of the region 1200 with the requisite correlation to one of the reference travel-paths 1205a-f and comprises arriving at the milestone locations 1265a-c within the associated time frame, then the normal entrance-behaviour condition could be considered satisfied.

However, if a current entrance-behaviour 1215a-c of the person transiting the region 1200 represented in the second set of RARWD measurements deviates from the at least one reference entrance-behaviour as represented by reference travel paths 1205a-f or milestones with respect to milestone locations 1265a-c, such that it does not have the requisite correlation with the at least one reference entrance-behaviour, then the normal entrance-behaviour condition could be considered not satisfied, again subject to the scenarios outlined in FIGS. 6 to 9.

Current entrance-behaviour 1215a derived from the second set of RARWD measurements represents a travel-path of a person first being detected at the location 1210 and initially following the reference travel-paths 1205a-f via a first milestone location 1265a before deviating away from the reference travel-paths 1205a-f so that they do not arrive within a threshold distance of the second milestone location within the associated timeframe. In this case, as the person deviated from the reference travel paths 1205a-f and did not arrive at the second milestone location within the associated timeframe, the current entrance-behaviour is determined not to have the required correlation with at least one reference-entrance-behaviour such that the normal entrance-behaviour condition is considered not satisfied. As a result, the output is controlled so as to indicate that the normal entrance-behaviour condition is not satisfied. Such control could comprise providing an indicative signal or not providing a signal. Not providing such a signal following a detected triggering-event associated with entry into the region could be in itself indicative of the normal entrance-behaviour condition not being satisfied, for example in embodiments in which a receiver of the signal is configured to expect the signal within a certain time window if a normal entrance-behaviour condition is satisfied.

Another example of current entrance-behaviour 1215b derived from the second set of RARWD measurements represents a travel-path of a person first detected at the location 1210 and initially following the reference travel-path 1205c and satisfied the first and second milestones at milestone locations 1265a and 1265b respectively. Most of the travel path of current entrance-behaviour 1215b corresponds to the reference travel-path 1205c of one of the reference entrance-behaviours but deviates beyond some predefined margin of error before the end of the reference travel-path 1205c. In this example, the current travel-path 1215b would have to follow, within the margin of error, substantially the whole length of the reference travel-path 1205c of the at least one reference entrance-behaviour for there to be a requisite correlation with the reference travel-path 1205c. As there is not the requisite correlation with reference travel-path 1205c (nor with any of the other reference entrance-behaviours), then the normal entrance-behaviour condition is not satisfied by current entrance-behaviour 1215b.

A further example of current entrance-behaviour 1215c derived from the second set of RARWD measurements represents a travel-path of a person first detected at the location 1210 and initially following the reference travel-path 1205c and who satisfied the first milestone with respect to the first milestone location 1265a. Thereafter the travel path represented in the current entrance-behaviour 1215c deviates from the reference travel-paths 1205a-f to a location 1270 where the person stops, before re-joining the reference travel-paths 1205a-f and arriving at the location of the second milestone 1265b. In this case, as the travel-path deviates significantly from the reference travel-paths 1205a-f, there is not the requisite correlation with the reference travel-paths 1205a-f. Furthermore, the stop at location 1270 delayed their arrival at the second milestone location 1265b such that they did not meet the milestone associated with that location (i.e. they did not arrive within a threshold distance of the second milestone location 1265b within the associated timeframe).

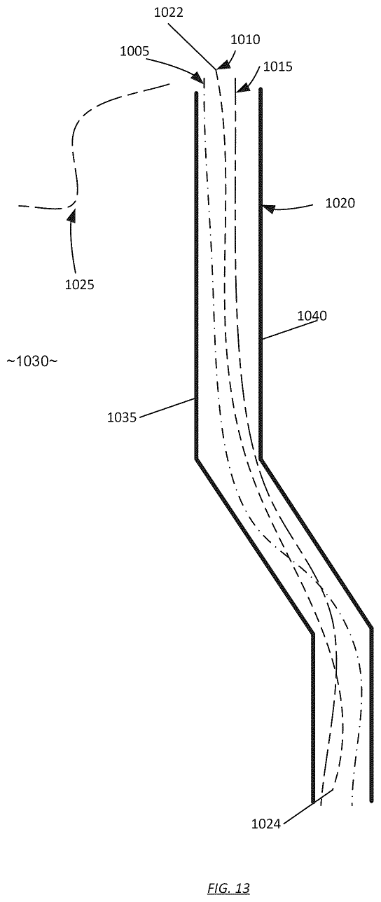

FIGS. 13 to 17 illustrate the formation and use of reference pathways for use in the at least one reference entrance-behaviour discussed in relation to FIG. 5. In these examples, the reference entrance-behaviour comprises traversing across at least part of the region through a pathway.

FIG. 13 illustrates formation of a pathway 1020. The pathway 1020 extends from a first location 1022 to a second location 1024. The first location 1022 is generally a location at which a human is first detected in the first set of RARWD measurements after an away period in which the region is determined to be vacant, optionally determined to be vacant for at least a minimum amount of time, e.g. 30 seconds or 1 minute. However, in some examples, a normal pathway through which a person travels could be broken down into multiple pathways, which in some examples are provided end to end. In such a case, the first location 1022 of a pathway 1020 could be a second (end) location of a preceding pathway.

The pathway 1020 is defined based on one or more travel-paths 1005, 1010, 1015 undertaken by a person in a reference entrance-behaviour of the at least one reference entrance-behaviours represented in the first set of RARWD measurements. For example, the pathway 1020 could encompass the one or more travel-paths 1005, 1010, 1015 and/or be based on a function of the one or more travel-paths 1005, 1010, 1015, such as a representative average of the one or more travel-paths 1005, 1010, 1015. The travel-paths 1005, 1010, 1015 in the reference entrance-behaviour are grouped or clustered together and groups or clusters of travel paths 1005, 1010, 1015 are combined together to form an associated pathway 1020.

For example, multiple travel-paths 1005, 1010, 1015 are determined to represent a single reference entrance-behaviour, and thereby define a single pathway 1020, based on the multiple travel-paths 1005, 1010, 1015 having a predetermined correlation with each other. For example, if a particular set of travel-paths 1005, 1010, 1015 have a predetermined correlation such as at least one of: a similar shape, have similar path lengths, and/or commence and end at similar locations, they are determined to represent a single reference entrance-behaviour, and be grouped to determine a single pathway 1020 that all of the travel paths 1005, 1010 and 1015 keep within. So, in the example of FIG. 13, travel paths 1005, 1010 and 1015 through the region 1030 from the first set of RARWD measurements are grouped into correspondence with a single pathway 1020 as they all start and finish within a defined proximity to each other and have over a threshold degree of similarity in shape and path length. However, travel-path 1025 is not grouped since its finish, shape and path length are too dissimilar to the other travel-paths 1005, 1010, 1015.

The pathway 1020 has lateral boundaries 1035, 1040 that laterally surround all of the one or more travel-paths in the reference entrance-behaviour. The lateral boundaries 1035, 1040 of the pathway 1020 could have a maximum or set distance from the one or more travel-paths 1005, 1010, 1015 or from the representative average or other function of the one or more travel-paths 1005, 1010, 1015 of the corresponding reference entrance-behaviour. Optionally, the pathway 1020 can have a maximum width, which could be a predefined value. However, other possibilities for determining a pathway correlated with the travel paths 1005, 1010, 1015 represented in a given reference entrance-behaviour could be used.

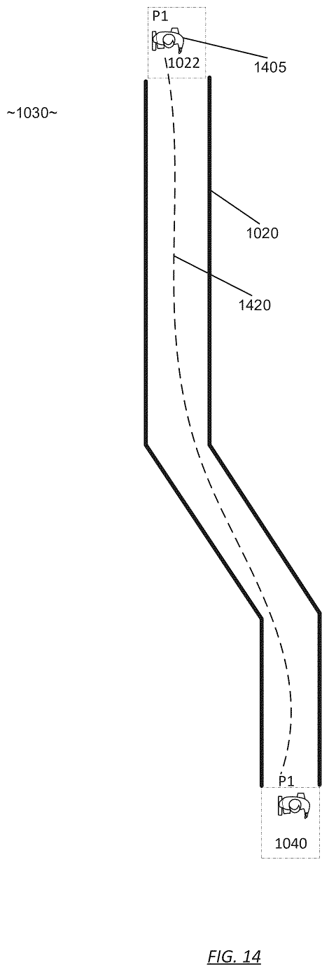

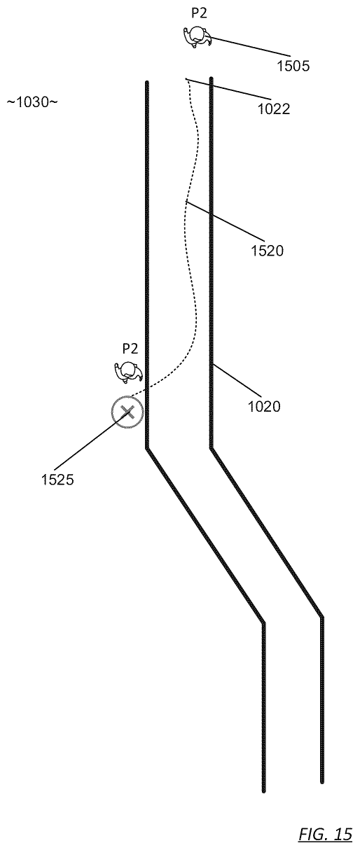

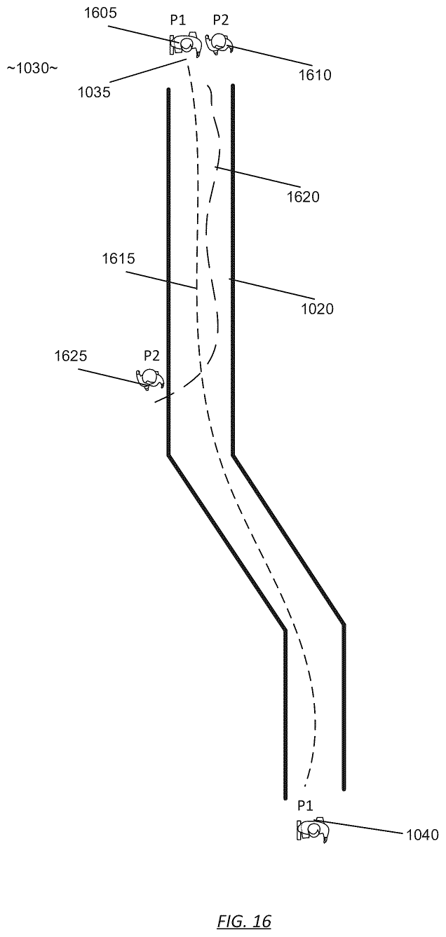

While FIG. 13 illustrates the formation of a pathway 1020, FIGS. 14 and 15 illustrate a determination of whether a current entrance-behaviour represented in the second set of RARWD measurements has a requisite correlation with the pathway 1020 associated with a reference entrance-behaviour. In this case, determining whether the current entrance-behaviour of the at least one person traversing the region has a requisite correlation with the at least one reference entrance-behaviour comprises determining whether the current entrance-behaviour comprises traversing from the first (starting) location 1022 to the second (end) location 1024 of the pathway 1020 without straying from the pathway 1020.

FIG. 14 shows an example of current entrance-behaviour of a person 1405 derived from the second set of RARWD measurements. The person 1405 enters the region 1030 that is being monitored by a system comprising at least one RARWD based sensing device, such as any of the RARWD sensing devices 10a, 210a, 310c-e, 400, 1225 shown and described in relation to FIGS. 1 to 4 and 12. The system detects the person 1405 entering the region 1030, which is classed as a triggering-event. The triggering event could be the same as triggering-events 625, 725, 820, 920, 1210 described above in relation to any of FIGS. 6 to 9 and 12. The person 1405 entering the system could be detected by the at least one RARWD sensing device and/or by a different device such as the motion sensing device 10c, 210c, 310a or the door or window state sensing device 10d, 210d, 310b shown in, and described in relation to, any of FIGS. 1 to 4 and 12. The location at which the triggering-event occurs (i.e. the point of entry into the region 1030) coincides with the first location 1022 of the pathway 1020. After entering the region 1030, the person 1405 traverses at least part of the region 1030 whilst being monitored by the at least one RARWD sensing device. Time-correlated locations of the person 1405 in at least two and preferably three dimensions is comprised in, or derivable from, the second set of RARWD measurements provided by the at least one RARWD sensing device. From this, it can be determined that the person 1405 traverses at least part of the region 1030 along a route 1420 from a location that is within a threshold distance of the first location 1022 of the reference pathway 1020 to a location within a threshold distance of the second location 1024 of the reference pathway 1020 without straying from the reference pathway 1020, as shown in FIG. 14. As such, it can be determined that the current entrance-behaviour of the at least one person 1405 (traversing the at least part of the region 1030 along the route 1420) has a requisite correlation with the at least one reference entrance-behaviour in the form of reference pathway 1020 such that a normal entrance-behaviour condition is satisfied. In view of this, the system 5, 205, 305, 400 controls output so as to be indicative of the normal entrance-behaviour condition being determined to be satisfied.

The controlling of the output could comprise, as examples, providing a signal indicating that the normal entrance-behaviour condition has been determined to be satisfied or not sending a signal that would be expected after the triggering-event has been detected, wherein the lack of a signal is indicative of the normal entrance-behaviour condition being determined to be satisfied. The controlling of the output can be used as part of a security system, such as an intruder alarm system, or other system with intruder detection and alarm functionality. This could be used, for example, to cancel or not raise an alarm or to take (or not take) a verification action, e.g. using another sensing device such as a camera, to verify or otherwise double check if an intruder is present or not.

FIG. 15 shows another example of current entrance-behaviour of a person 1405 derived from the second set of RARWD measurements. FIG. 15 shows the same reference pathway 1020 whose creation is shown in FIG. 13 and whose use in a scenario is shown in FIG. 14. As in the example of FIG. 14, a person 1505 enters the region 1030 that is being monitored by the system comprising the at least one RARWD based sensing device. The system detects the person 1505 entering the region 1030, which is classed as a triggering-event. The location at which the triggering-event occurs (i.e. the point of entry into the region 1030) coincides with the first location 1022 of the pathway 1020. After entering the region 1030, the person 1505 traverses at least part of the region 1030 whilst being monitored by the at least one RARWD sensing device. From this, it can be determined that the person 1505 traverses part of the region 1030 along a route 1520 from a location that is within a threshold distance of the first location 1022 of the reference pathway 1020 and that initially follows the reference pathway 1020 but then deviates out of the reference pathway 1020 to a second location 1525 that is outside of the reference pathway 1020.

From this, it can be determined that the current entrance-behaviour of the at least one person 1505 (traversing the at least part of the region 1030 along the route 1520) does not have a requisite correlation with the at least one reference entrance-behaviour in the form of reference pathway 1020 such that a normal entrance-behaviour condition is not satisfied. Based on this, the system 5, 205, 305, 400 controls output so as to be indicative of the normal entrance-behaviour condition being determined not to be satisfied.

The controlling of the output could comprise, as examples, providing a signal indicating that the normal entrance-behaviour condition has been determined not to be satisfied or not sending a signal that would be expected after the triggering-event has been detected, wherein the lack of a signal is indicative of the normal entrance-behaviour condition being determined not to be satisfied. Again, the controlling of the output can be used as part of a security system, such as an intruder alarm system, or other system with intruder detection and alarm functionality. This could be used, for example, to raise an alarm (or at least to not block the raising of an alarm after detection of the triggering-event) or to take (or not take) a verification action, e.g. using another sensing device such as a camera, to verify or otherwise double check if an intruder is present or not, or to send an intruder notification to at least one recipient.

FIG. 16 shows a scenario in which there are two people 1605, 1610 who arrive at, or within a threshold distance of, the first location 1022 at the same time, or at least within a threshold time of each other, and traverse the region 1030 at substantially the same time. In this case, the two (or more) people 1605, 1610 are treated as acting according to a collective entrance-behaviour. This type of situation could apply, for example, where a family or group of friends arrives home together. In this case, the system has to apply appropriate logic to deal with this situation.

Both of the people 1605, 1610 enter the region 1030 that is being monitored by the system comprising the at least one RARWD based sensing device. The system detects the people 1605, 1610 entering the region 1030, which is classed as a triggering-event. The location at which the triggering-events occur coincides with the first location 1022 of the pathway 1020. After entering the region 1030, both people 1605, 1610 traverse at least part of the region 1030 along routes 1615, 1620 that initially follow the reference pathway 1020. One of the people 1605 continues along a route that follows the reference pathway 1020 without straying from it until they reach the second location 1630 on the pathway 1020, similarly to the scenario shown in FIG. 14. However, the other person 1610 takes a route 1620 that deviates off the pathway 1020 to a location 1625 that is outwith the pathway, similar to the scenario shown in FIG. 15. The people 1605, 1610 are monitored by the at least one RARWD sensing device whilst traversing the region 1030.

The response of the system to this scenario of FIG. 16 depends on which arrangement for their collective entrance-behaviour is required. Though in this example the normal entrance-behaviour is defined in terms of a pathway 1020, there are two choices that are considered here which are analogous to the different examples shown in FIG. 8 or 9 for normal entrance-behaviour defined in terms of travel paths. If the arrangement like that of FIG. 8 were used in the example of FIG. 16, then all of the people 1605, 1610 would have to traverse the region 1030 without straying from the pathway 1020 for the current collective entrance-behaviour of the at least one person 1605, 1610 to have a requisite correlation with the at least one reference entrance-behaviour. As this is not the case in the example of FIG. 16, then a normal entrance-behaviour condition would not be satisfied in this case.

In contrast, if the arrangement like that of FIG. 9 were used in the example of FIG. 16, the current collective entrance-behaviour of the at least one person 1605, 1610 would have a requisite correlation with the at least one reference entrance-behaviour if any of the people 1605, 1610 traverse the region 1030 without straying from the pathway 1020. In this case, since the route 1615 taken by the person 1605 does not stray from the pathway 1020, then the normal entrance-behaviour condition is satisfied.

In another example based on FIG. 16, both the pathway 1020 and at least one milestone can be used in the reference entrance-behaviour. In this example, in order for there to be a requisite correlation with the at least one reference entrance-behaviour, at least one person 1605, 1610 must both traverse the region 1030 from the first location 1022 to the second location 1024 without straying from the pathway 1020 and also arrive at a milestone location corresponding to the second location 1024 within an associated time period from the detection of the trigger-event. In this example, if both of these conditions are met, then it is determined that the current collective entrance-behaviour has the requisite correlation with the at least one reference behaviour and thereby the normal entrance-behaviour condition is satisfied. However, if any of these conditions are not met, then it is determined that the current collective entrance-behaviour does not have the requisite correlation with the at least one reference behaviour and thereby the normal entrance-behaviour condition is not satisfied.

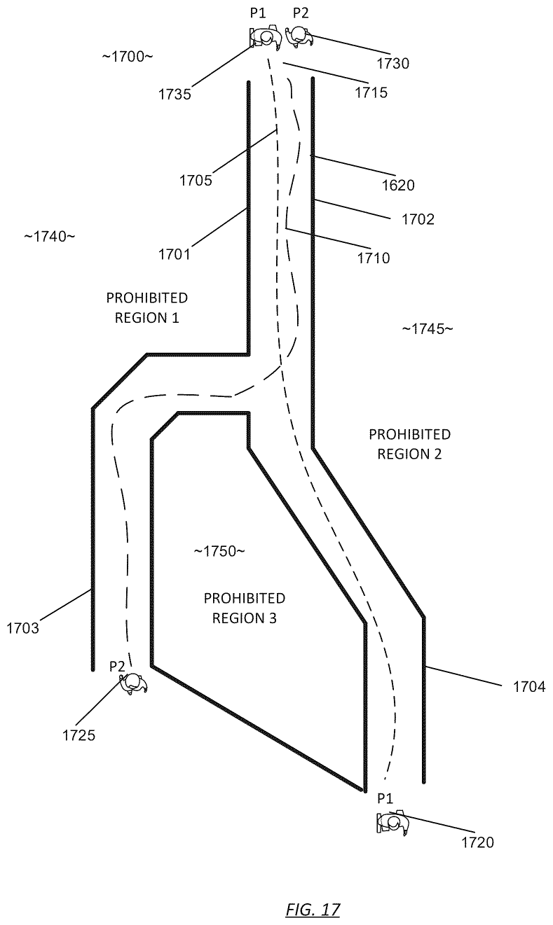

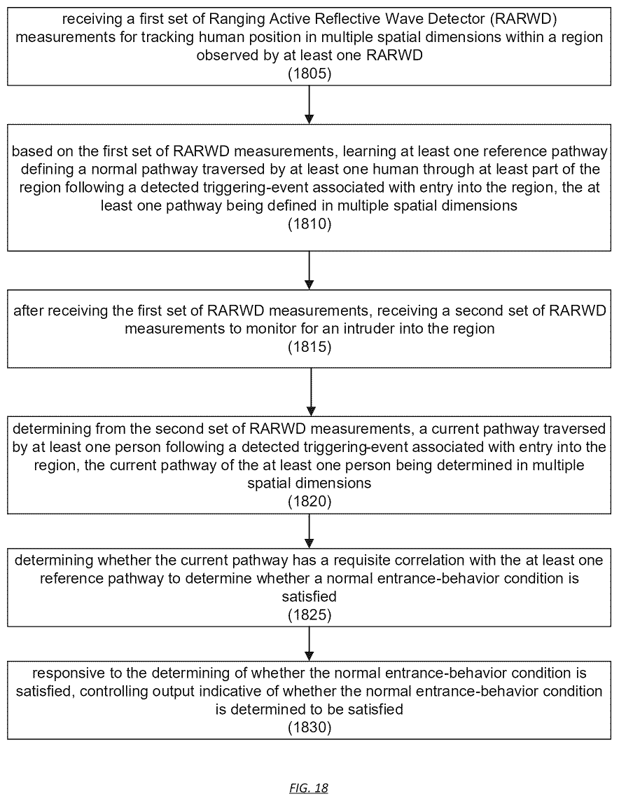

FIG. 17 shows a further example that corresponds to the conditions described in relation to FIG. 8 in which every person detected to be in a region 1700 must traverse the region 1700 without straying from a pathway 1701 in order for the current entrance-behaviour to have the requisite correlation with the at least one reference behaviour so that the normal entrance-behaviour condition would be satisfied. In this example, the pathway 1701 is branched so that there is more than one possible way to traverse the region without straying from the pathway 1701. In this example, the pathway 1701 has a common part 1702 and two separate branches 1703 and 1704 that extend to different sides of a prohibited region 1750. In this case, a travel path that does not stray from the common part 1702 and any of the separate branches 1704 or 1704 may be deemed to have the requisite correlation with the pathway 1701.

In the example of FIG. 17, each of two (or more) different people 1730, 1735 traverse the region 1700 along respective travel paths 1705 and 1710 that start from a common first location 1715 and are initially coincident before diverging to different second locations 1720, 1725. Essentially, the common part 1702 and all branches 1703, 1704 of the pathway 1701 together form a “permitted region” and the other parts of the region form “prohibited regions” 1740, 1745, 1750. In this case, the current entrance-behaviour is determined to have the requisite correlation if every person 1730, 1735 detected to be in the region 1700 traverses the region 1700 without deviating from the “permitted region” that consists of the pathway 1701, including the common part 1702 and all branches 1703, 1704 of the pathway 1701. Conversely, if any of the people 1730, 1735 detected to be in the region 1700 deviate from the “permitted region” into a “prohibited region” 1740, 1745, 1750 whilst traversing the region 1700 then the current entrance-behaviour is determined to not to have the requisite correlation.

Of course, the present disclosure is not limited to the specific examples described above. For example, the requirements for multiple people being detected in the region outlined above in relation to any of FIGS. 6 to 8 can be applied to any of the ways of determining reference entrance-behaviour and current entrance-behaviour and the requisite correlation therebetween that are described above in relation to FIGS. 9 to 17. Furthermore any of the forms of reference entrance-behaviour and current entrance-behaviour and the requisite correlation therebetween that are described above in relation to FIGS. 9 to 17 can be used in any appropriate combination with any other of the forms of reference entrance-behaviour and current entrance-behaviour and the requisite correlation therebetween that are described above in relation to FIGS. 9 to 17, and that these could be combined by requiring that either all or any of the requirements associated with the different forms are met in order for there to be a requisite correlation.

In addition, although FIGS. 1 to 4 show various examples of systems and devices that could be used to carry out the method of FIG. 5 and/or used to perform the approaches outlined in relation to any of FIGS. 6 to 17, the present disclosure is not limited to these and other appropriate hardware could be used.

Furthermore, the method described in relation to FIG. 5 could be performed using any of the systems or devices described in relation to FIGS. 1 to 4, or in the examples discussed in relation to any of FIGS. 6 to 17. However, specific variations of the method of FIG. 5 could be applied to some of the examples listed above.

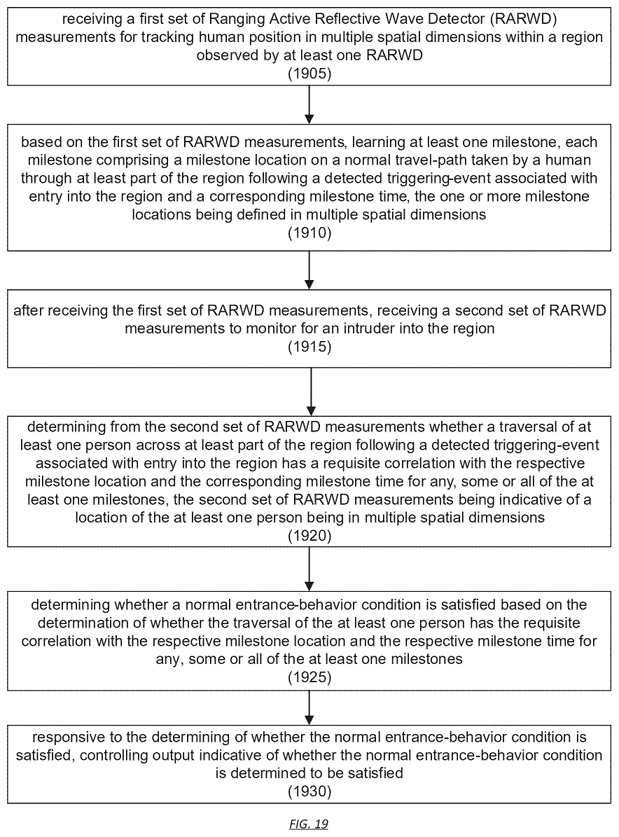

FIG. 18 shows an example of a method that could be used with any of the methods that use pathways, such as those described in relation to any of FIGS. 13 to 17.

At 1805 a first set of Ranging Active Reflective Wave Detector (RARWD) measurements for tracking human position in multiple spatial dimensions within a region observed by at least one RARWD are received.

At 1810, based on the first set of RARWD measurements, at least one reference pathway defining a normal pathway traversed by at least one human through at least part of the region following a detected triggering-event associated with entry into the region is learned, the at least one pathway being defined in multiple spatial dimensions.

At 1815, after receiving the first set of RARWD measurements, a second set of RARWD measurements are received to monitor for an intruder into the region.

At 1820, from the second set of RARWD measurements, a current pathway traversed by at least one person following a detected triggering-event associated with entry into the region is determined, the current pathway of the at least one person being determined in multiple spatial dimensions.

At 1825 it is determined whether the current pathway has a requisite correlation with the at least one reference pathway to determine whether a normal entrance-behaviour condition is satisfied.

At 1830 output indicative of whether the normal entrance-behaviour condition is determined to be satisfied is controlled responsive to the determining of whether the normal entrance-behaviour condition is satisfied.

The output could be used as part of an identification of an intruder in the operation of an alarm system, as described above.

FIG. 19 shows an example of a method that could be used with any of the methods that use travel-paths, such as those described in relation to any of FIG. 6 to 9 or 12.

At 1905 a first set of Ranging Active Reflective Wave Detector (RARWD) measurements are received for tracking human position in multiple spatial dimensions within a region observed by at least one RARWD.

At 1910, based on the first set of RARWD measurements, at least one milestone is learned, each milestone comprising a milestone location on a normal travel-path taken by a human through at least part of the region following a detected triggering-event associated with entry into the region and a corresponding milestone time, the one or more milestone locations being defined in multiple spatial dimensions.

At 1915, after receiving the first set of RARWD measurements, a second set of RARWD measurements are received to monitor for an intruder into the region.

At 1920, it is determined from the second set of RARWD measurements whether a traversal of at least one person across at least part of the region following a detected triggering-event associated with entry into the region has a requisite correlation with the respective milestone location and the corresponding milestone time for any, some or all of the at least one milestones, the second set of RARWD measurements being indicative of a location of the at least one person being in multiple spatial dimensions.

At 1925, it is determined whether a normal entrance-behaviour condition is satisfied based on the determination of whether the traversal of the at least one person has the requisite correlation with the respective milestone location and the respective milestone time for any, some or all of the at least one milestones.

At 1920 an output indicative of whether the normal entrance-behaviour condition is determined to be satisfied is controlled responsive to the determining of whether the normal entrance-behaviour condition is satisfied.

The output could be used as part of an identification of an intruder in the operation of an alarm system, as described above.

The term “module,” as used herein generally represent software, firmware, hardware, or a combination thereof. In the case of a software implementation, the module represents program code that performs specified tasks when executed on a processor (e.g. CPU or CPUs). The program code can be stored in one or more computer readable memory devices.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

References to a processor is made herein and any of the methods described herein could be implemented at least in part on a processor. However, the use of processor herein should not be construed narrowly and could include a multi-core processor. Furthermore, the processor could be or include but are not limited to at least one of: one or more digital signal processors (DSPs), one or more field programmable gate arrays (FPGAs), one or more integrated FPGA/processor systems, one or more application specific integrated circuits (ASICS), an adaptive compute acceleration platform (ACAP), one or more system on chip (SoC) devices, one or more maths co-processors, one or more AI accelerators such as a tensor processing unit (TPU), one or more graphics processing units (GPUs) and the like.

At least part of the processes described herein could be implemented using software that is processed by suitable hardware to perform at least part of the process. This could be implemented by a computer. The term “computer” as used herein could be any electronic processing device or system, for example as described herein.

As such, the specific examples are provided herein to aid the understanding of the reader and the scope of the present disclosure is not limited by the specific examples described herein.

As used herein, unless context demands otherwise, the expression “one or more of x and y” or “at least one of x and y”, should be interpreted to cover: (i) at least one x, (ii) at least one y, (iii) at least one x and at least one y. That is, there may be, but need not be, both element x and element y. The same applies to any equivalent expressions referring to more than two elements, e.g., the expression “at least one of x, y, and z”. The same interpretation should likewise be applied to the expressions “x, y, and/or z” and “at least x, y, and/or z”.

As used herein, except where the context requires otherwise, the terms “comprises”, “includes”, “has”, and grammatical variants of these terms, are not intended to be exhaustive. They are intended to allow for the possibility of further additives, components, integers or steps.

Consistent with the present disclosure, each of the following represent a respective exemplary embodiment of the present invention.

A first embodiment which is a computer-implemented method of for monitoring a region to detect an intruder. The method comprises receiving a first set of Ranging Active Reflective Wave Detector (RARWD) measurements for tracking human position in multiple spatial dimensions within a region observed by at least one RARWD; obtaining at least one reference entrance-behaviour based on the first set of RARWD measurements, the at least one reference entrance-behaviour defining at least one normal human transit behaviour through at least part of the region following a detected triggering-event associated with entry into the region, the at least one normal human transit behaviour comprising a characteristic defined in multiple spatial dimensions; after receiving the first set of RARWD measurements, receiving a second set of RARWD measurements to monitor for an intruder into the region; determining from the second set of RARWD measurements a current entrance-behaviour of at least one person following a detected triggering-event associated with entry into the region, the current entrance-behaviour being determined with respect to multiple spatial dimensions; determining whether the current entrance-behaviour of the at least one person has a requisite correlation with the at least one reference entrance-behaviour to determine whether a normal entrance-behaviour condition is satisfied; and responsive to the determining of whether the normal entrance-behaviour condition is satisfied, controlling output indicative of whether the normal entrance-behaviour condition is determined to be satisfied. In some embodiments, the method comprises using the second set of RARWD measurement to track the spatial location of the at least one person to determine the current entrance-behaviour of the least one person. Additionally or alternatively, in some embodiments, the current-entrance-behaviour and/or the reference entrance-behaviour are behaviours of entering the region immediately following a period in which the region is vacant; and the method comprises determining when the region is vacant of humans prior to the entry into the region.

A second embodiment, which is the method of any preceding embodiment, wherein the detected triggering-event that is followed by the current entrance-behaviour and the detected triggering-event that is followed by the at least one normal human transit behaviour are required to be sensed by: a same sensing device or any sensing device of a same set sensing devices.

A third embodiment, which is the method of any preceding embodiment, wherein: the at least one reference entrance-behaviour is learned based on the first set of RARWD measurements; and the at least one reference entrance-behaviour is learned during a defined learning period, and each of the at least normal human transit behaviours represent any human transit behaviour that is detected as occurring during the defined learning period.

A fourth embodiment, which is the method of any preceding embodiment, wherein the determining from the second set of RARWD measurements whether the current entrance-behaviour of at least one person has a requisite correlation with the at least one reference entrance-behaviour may comprise determining whether the current entrance-behaviour of each person has a requisite correlation with any reference entrance-behaviour of the least one reference entrance-behaviours.

A fifth embodiment, which is the method of any preceding embodiment one to three, wherein the determining from the second set of RARWD measurements whether the current entrance-behaviour of at least one person has a requisite correlation with the at least one reference entrance-behaviour comprises determining whether the current entrance-behaviour of each person has a requisite correlation with a particular reference entrance-behaviour of the least one reference entrance-behaviours.

A sixth embodiment, which is the method of any preceding embodiment, wherein the at least one reference entrance-behaviour is defined in relation to one or more instances of a triggering event associated with entry into the region, and each of the at least one normal human transit behaviours represent a human transit behaviour being performed one or more times, each of the one or more times following respective one or more instances of a triggering event associated with entry into the region.

A seventh embodiment, which is the method of any preceding embodiment, wherein the normal human transit behaviour represents a human transit behaviour being performed more than one time, and the reference entrance-behaviour corresponds to a representative average of the more than one times.

An eighth embodiment, which is the method of any preceding embodiment, wherein each of the at least one reference entrance-behaviours comprises or consists of one or more aspects of behaviour, the one or more aspects of behaviour comprising one or more of: arriving at a first milestone location associated with a first milestone event; arriving at second milestone location associated with a second milestone event; traversing at least part of the region according to a travel-path; and/or traversing at least part of the region through a pathway.

A ninth embodiment, which is the method of the eight embodiment, wherein the method comprises analyzing the first set of RARWD measurements to identify the first milestone event and/or the second milestone event based on a detected object performing one or more predefined milestone features of the respective first and/or second milestone event, wherein the milestone features comprise at least one of: human travel of a predefined distance since being at a defined previous location; human travel of a predefined displacement from a defined previous location; a predefined amount of time having passed since a human entered the region or since a triggering event; changing speed of movement in a predetermined manner by a human after commencing a transit through at least part of the region; and/or changing direction of movement in a predetermined manner by a human after commencing a transit through at least part of the region.

A tenth embodiment, which is the method of the ninth embodiment, wherein, for the second milestone event, the defined previous location is the first milestone location.

An eleventh embodiment, which is the method of the ninth embodiment or the tenth embodiment, wherein the changing speed of movement in a predetermined manner comprises at least one of: stopping, pausing or otherwise changing speed from a non-zero speed to being stationary.

A twelfth embodiment, which is the method of any preceding embodiment eight to eleven, wherein determining whether the current entrance-behaviour of the at least one person has a requisite correlation with the at least one reference entrance-behaviour comprises determining whether the current entrance-behaviour comprises one or both of: arriving at or within a predefined proximity to the first milestone location within a first predefined time frame; and/or arriving at or within a predefined proximity to the second milestone location within a second predefined time frame.

A thirteenth embodiment, which is the method of the twelfth embodiment, wherein: the first predefined time frame is associated with a predefined amount of time having passed since a human entered the region or since a triggering event; and/or the second predefined time frame is associated with a predefined amount of time having passed since a human entered the region or since a triggering event or since arriving at or leaving the first milestone location.

An fourteenth embodiment, which is the method of any preceding embodiment, wherein the at least one reference-entrance-behaviour comprises traversing at least part of the region according to a travel-path and/or through a pathway.

A fifteenth embodiment, which is the method of the fourteenth embodiment, wherein the travel-path and/or pathway is defined as commencing at a location at which a human is first detected in the first set of RARWD measurements after an away period in which the region is determined to be vacant for at least a minimum amount of time.

A sixteenth embodiment, which is the method of the fourteenth embodiment or fifteenth embodiment, wherein determining whether the current entrance-behaviour of the at least one person has a requisite correlation with the at least one reference entrance-behaviour comprises determining whether the current entrance-behaviour comprises traversing at least part of the region according to a current travel-path that has a requisite consistency with a travel-path in the at least one reference entrance-behaviour, wherein the requisite consistency comprises at least one of: that the current travel-path has a current path length having a minimum correlation with a reference path length of a travel-path in the at least one reference entrance-behaviour; that the current travel-path has a start location and an end location that are the same as, or within a predefined maximum distance of, a respective start location and end location of said travel-path in the at least one reference entrance-behaviour; and/or that the current travel-path has directional consistency with said travel-path in the at least one reference entrance-behaviour, the directional consistency being determined by comparing directional attributes of the current travel-path and said travel-path in the at least one reference entrance-behaviour.

A seventeenth embodiment, which is the method of any preceding embodiment fourteenth to sixteenth, wherein, the one or more travel-paths comprises multiple travel-paths and the multiple travel-paths are determined to represent a single reference entrance-behaviour based on the multiple travel-paths having a predetermined correlation with each other, the predetermined correlation comprising a particular set of travel-paths being at least one or all of: a similar shape, having similar path lengths, and/or commencing and ending at similar locations.

An eighteenth embodiment, which is the method of any preceding embodiment, wherein the at least one reference entrance-behaviour is dependent on one or both of: contextual conditions, wherein the current entrance-behaviour occurs under said contextual conditions; and/or a time of entry into the region.

A nineteenth embodiment, which is the method of any preceding embodiment, wherein the triggering event comprises an indication of an object-entry event, wherein the object-entry event may be a specific one or may be any of: a full or partial disarming of a security system associated with the region; a detected change in a door state of a door associated with the region; a detected passage of a person through an entry associated with the region or a physically partitioned portion therein; a detected passage of a person into the region; and/or a detected presence or motion at an entry location at which the region can be entered.

A twentieth embodiment, which is the method of any preceding embodiment, wherein the at least one RARWD comprises at least one multidimensional RADAR.

A twenty-first embodiment, which is the method of any preceding embodiment, comprising learning, based on the first set of RARWD measurements, the at least one reference entrance-behaviour, wherein the learning is performed on a different device to a device that collects the first set of RARWD measurements.

A twenty-second embodiment, which is the method of any preceding embodiment one to twentieth, wherein the obtaining of the at least one reference entrance-behaviour comprises: transmitting the first set of RARWD measurements or data derived therefrom or indicative thereof, to the different device that performs learning of the at least one reference entrance-behaviour based on the first set of RARWD measurements; and receiving the at least one reference entrance-behaviour from the different device that performs the learning based on the first set of RARWD measurements.

A twenty-third embodiment, which is a processing system configured for monitoring a region to detect an intruder. The system is configured to receive a first set of Ranging Active Reflective Wave Detector (RARWD) measurements for tracking human position in multiple spatial dimensions within a region observed by at least one RARWD; obtain at least one reference entrance-behaviour based on the first set of RARWD measurements, the at least one reference entrance-behaviour defining at least one normal human transit behaviour through at least part of the region following a detected triggering-event associated with entry into the region, the at least one normal human transit behaviour comprising a characteristic defined in multiple spatial dimensions; after receiving the first set of RARWD measurements, receive a second set of RARWD measurements to monitor for an intruder into the region; determine from the second set of RARWD measurements a current entrance-behaviour of at least one person following a detected triggering-event associated with entry into the region, the current entrance-behaviour being determined with respect to multiple spatial dimensions; determine whether the current entrance-behaviour of the at least one person has a requisite correlation with the at least one reference entrance-behaviour to determine whether a normal entrance-behaviour condition is satisfied; and responsive to the determining of whether the normal entrance-behaviour condition is satisfied, control output indicative of whether the normal entrance-behaviour condition is determined to be satisfied. In some embodiments, the system is configured to use the second set of RARWD measurement to track the spatial location of the at least one person to determine the current entrance-behaviour of the least one person. Additionally or alternatively, in some embodiments, in which the current-entrance-behaviour and/or the reference entrance-behaviour are behaviours of entering the region immediately following a period in which the region is vacant, the system is configured to determine when the region is vacant of humans prior to the entry into the region.

A twenty-fourth embodiment, which is a system configured for monitoring a region to detect an intruder, the system comprising a plurality of Ranging Active Reflective Wave Detectors (RARWDs). The system is configured to collect a first set of RARWD measurements for tracking human position in multiple spatial dimensions within a region observed by at least one RARWD of the plurality of RARWDs; obtain at least one reference entrance-behaviour based on the first set of RARWD measurements, the at least one reference entrance-behaviour defining at least one normal human transit behaviour through at least part of the region following a detected triggering-event associated with entry into the region, the at least one normal human transit behaviour comprising a characteristic defined in multiple spatial dimensions; after receiving the first set of RARWD measurements, receive a second set of RARWD measurements observed by at least one RARWD of the plurality of RARWDs to monitor for an intruder into the region; determine from the second set of RARWD measurements a current entrance-behaviour of at least one person following a detected triggering-event associated with entry into the region, the current entrance-behaviour being determined with respect to multiple spatial dimensions; determine whether the current entrance-behaviour of the at least one person has a requisite correlation with the at least one reference entrance-behaviour to determine whether a normal entrance-behaviour condition is satisfied; and responsive to whether the normal entrance-behaviour condition is determined to be satisfied, control output indicative of whether the normal entrance-behaviour condition is determined to be satisfied. In some embodiments, the system is configured to use the second set of RARWD measurement to track the spatial location of the at least one person to determine the current entrance-behaviour of the least one person. Additionally or alternatively, in some embodiments, in which the current-entrance-behaviour and/or the reference entrance-behaviour are behaviours of entering the region immediately following a period in which the region is vacant, the system is configured to determine when the region is vacant of humans prior to the entry into the region.

A twenty-fifth embodiment, which is a device configured for monitoring a region to detect an intruder, the device comprising at least one Ranging Active Reflective Wave Detector (RARWD). The device is configured to collect a first set of RARWD measurements for tracking human position in multiple spatial dimensions within a region observed by the at least one RARWD; obtain at least one reference entrance-behaviour based on the first set of RARWD measurements, the at least one reference entrance-behaviour defining at least one normal human transit behaviour through at least part of the region following a detected triggering-event associated with entry into the region, the at least one normal human transit behaviour comprising a characteristic defined in multiple spatial dimensions; after receiving the first set of RARWD measurements, receive a second set of RARWD measurements observed by the at least one RARWD to monitor for an intruder into the region; determine from the second set of RARWD measurements a current entrance-behaviour of at least one person following a detected triggering-event associated with entry into the region, the current entrance-behaviour being determined with respect to multiple spatial dimensions; determine whether the current entrance-behaviour of the at least one person has a requisite correlation with the at least one reference entrance-behaviour to determine whether a normal entrance-behaviour condition is satisfied; and responsive to whether the normal entrance-behaviour condition is determined to be satisfied, control output indicative of whether the normal entrance-behaviour condition is determined to be satisfied. In some embodiments, the device is configured to use the second set of RARWD measurement to track the spatial location of the at least one person to determine the current entrance-behaviour of the least one person. Additionally or alternatively, in some embodiments, in which the current-entrance-behaviour and/or the reference entrance-behaviour are behaviours of entering the region immediately following a period in which the region is vacant, the device is configured to determine when the region is vacant of humans prior to the entry into the region.

A twenty-sixth embodiment, which is a non-transitory computer readable carrier medium having stored thereon instructions configured such that, when executed by a processing system, configure the processing system to monitor a region to detect an intruder using a process that comprises receiving a first set of Ranging Active Reflective Wave Detector (RARWD) measurements for tracking human position in multiple spatial dimensions within a region observed by at least one RARWD; obtaining at least one reference entrance-behaviour based on the first set of RARWD measurements, the at least one reference entrance-behaviour defining at least one normal human transit behaviour through at least part of the region following a detected triggering-event associated with entry into the region, the at least one normal human transit behaviour comprising a characteristic defined in multiple spatial dimensions; after receiving the first set of RARWD measurements, receiving a second set of RARWD measurements to monitor for an intruder into the region; determining from the second set of RARWD measurements a current entrance-behaviour of at least one person following a detected triggering-event associated with entry into the region, the current entrance-behaviour being determined with respect to multiple spatial dimensions; determining whether the current entrance-behaviour of the at least one person has a requisite correlation with the at least one reference entrance-behaviour to determine whether a normal entrance-behaviour condition is satisfied; and responsive to whether the normal entrance-behaviour condition is determined to be satisfied, control output indicative of whether the normal entrance-behaviour condition is determined to be satisfied. In some embodiments, the process comprises using the second set of RARWD measurement to track the spatial location of the at least one person to determine the current entrance-behaviour of the least one person. Additionally or alternatively, in some embodiments, in which the current-entrance-behaviour and/or the reference entrance-behaviour are behaviours of entering the region immediately following a period in which the region is vacant, the process comprises determining when the region is vacant of humans prior to the entry into the region.

A twenty-seventh embodiment, which is a computer-implemented method for monitoring a region to detect an intruder. The method comprises receiving a first set of Ranging Active Reflective Wave Detector (RARWD) measurements for tracking human position in multiple spatial dimensions within a region observed by at least one RARWD; obtaining at least one reference pathway based on the first set of RARWD measurements, the at least one reference pathway defining a normal pathway traversed by at least one human through at least part of the region following a detected triggering-event associated with entry into the region, the at least one pathway being defined in multiple spatial dimensions; after receiving the first set of RARWD measurements, receiving a second set of RARWD measurements to monitor for an intruder into the region; determining from the second set of RARWD measurements, a current pathway traversed by at least one person following a detected triggering-event associated with entry into the region, the current pathway of the at least one person being determined in multiple spatial dimensions; determining whether the current pathway has a requisite correlation with the at least one reference pathway to determine whether a normal entrance-behaviour condition is satisfied; and responsive to the determining of whether the normal entrance-behaviour condition is satisfied, controlling output indicative of whether the normal entrance-behaviour condition is determined to be satisfied.

A twenty-eighth embodiment, which is the method of preceding embodiment twenty-seven, wherein the at least one reference pathway and/or the current pathway are defined as extending from a location at which a human is first detected, which may be after an away period in which the region is determined to be vacant.

A twenty-ninth embodiment, which is the method of the twenty-seventh embodiment or the twenty-eighth embodiment, wherein at least one or each of the at least one reference travel-path comprises a pathway, and the reference travel-path is a travel-path along the pathway, wherein the requisite correlation comprises the current travel-path not deviating from the pathway of the at least one reference travel-path by more than a threshold amount along any or all of the pathway or a defined proportion of the pathway.

A thirtieth embodiment, which is a computer-implemented method for monitoring a region to detect an intruder. The method comprises receiving a first set of Ranging Active Reflective Wave Detector (RARWD) measurements for tracking human position in multiple spatial dimensions within a region observed by at least one RARWD; obtaining at least one milestone based on the first set of RARWD measurements, each milestone comprising a milestone location on a normal travel-path taken by a human through at least part of the region following a detected triggering-event associated with entry into the region and a corresponding milestone time, the one or more milestone locations being defined in multiple spatial dimensions; after receiving the first set of RARWD measurements, receiving a second set of RARWD measurements to monitor for an intruder into the region; determining from the second set of RARWD measurements whether a traversal of at least one person across at least part of the region following a detected triggering-event associated with entry into the region has a requisite correlation with the respective milestone location and the corresponding milestone time for any, some or all of the at least one milestones, the second set of RARWD measurements being indicative of a location of the at least one person being in multiple spatial dimensions; determining whether a normal entrance-behaviour condition is satisfied based on the determination of whether the traversal of the at least one person has the requisite correlation with the respective milestone location and the respective milestone time for any, some or all of the at least one milestones; and responsive to the determining of whether the normal entrance-behaviour condition is satisfied, controlling output indicative of whether the normal entrance-behaviour condition is determined to be satisfied.

A thirty-first embodiment, which is the method of the thirtieth embodiment, wherein the determining of whether the traversal of at least one person across at least part of the region has the requisite correlation comprises the at least one person being within the defined or predefined proximity to the milestone location within a time frame comprising the corresponding milestone time.

A third-second embodiment, which is the method of the thirtieth embodiment or the thirty-first embodiment, wherein the one or more milestone events comprise a plurality of milestone events in an ordered sequence; and the determining of whether the traversal of at least one person across at least part of the region has the requisite correlation comprises determining whether the at least one person traversing at least part of the region arrived at the respective milestone location, or was within the predefined proximity to the milestone location, at the respective milestone time for some or all of the at least one milestones in a same order as in the ordered sequence.

A thirty-third embodiment, which is the method of the thirtieth embodiment to the thirty-second embodiment, wherein each milestone is defined by a milestone event and the milestone events comprise at least one of: human travel of a predefined distance since being at a defined previous location; human travel of a predefined displacement from a defined previous location; a predefined amount of time having passed since a human entered the region or since a triggering event; changing speed of movement in a predetermined manner by a human after commencing a transit through at least part of the region; and changing direction of movement in a predetermined manner by a human after commencing a transit through at least part of the region.

A thirty-fourth embodiment, which is the method of the thirty-third embodiment, wherein, for the second milestone, the defined previous location is the first milestone location.

1. An apparatus configured for monitoring a region to detect an intruder, the apparatus comprising at least one Ranging Active Reflective Wave Detector (RARWD) the apparatus being configured to:
collect a first set of RARWD measurements for tracking human position in multiple spatial dimensions within a region observed by the at least one RARWD;
obtain at least one reference entrance-behaviour based on the first set of RARWD measurements, the at least one reference entrance-behaviour defining at least one normal human transit behaviour through at least part of the region following a detected triggering-event associated with entry into the region, the at least one normal human transit behaviour comprising a characteristic defined in multiple spatial dimensions;
after receiving the first set of RARWD measurements, receive a second set of RARWD measurements observed by the at least one RARWD to monitor for an intruder into the region;
determine from the second set of RARWD measurements a current entrance-behaviour of at least one person following a detected triggering-event associated with entry into the region, the current entrance-behaviour being determined: with respect to multiple spatial dimensions and using the second set of RARWD measurements to track the spatial location of the at least one person;
determine whether the current entrance-behaviour of the at least one person has a requisite correlation with the at least one reference entrance-behaviour to determine whether a normal entrance-behaviour condition is satisfied; and
responsive to whether the normal entrance-behaviour condition is determined to be satisfied, control output indicative of whether the normal entrance-behaviour condition is determined to be satisfied.

2. The apparatus of claim 1, wherein: the at least one reference entrance-behaviour is learned based on the first set of RARWD measurements; and the at least one reference entrance-behaviour is learned during a defined learning period, and each of the at least one normal human transit behaviours represent any human transit behaviour that is detected as occurring during the defined learning period.

3. The apparatus of claim 1, wherein the at least one reference entrance-behaviour is defined in relation to one or more instances of a triggering event associated with entry into the region, and each of the at least one normal human transit behaviours represent a human transit behaviour being performed one or more times, each of the one or more times following respective one or more instances of a triggering event associated with entry into the region.

4. The apparatus of claim 1, wherein each of the at least one reference entrance-behaviours comprises or consists of one or more aspects of behaviour, the one or more aspects of behaviour comprising one or more of:
arriving at a first milestone location associated with a first milestone event;
arriving at a second milestone location associated with a second milestone event;
traversing at least part of the region according to a travel-path; and/or
traversing at least part of the region through a pathway.

5. The apparatus of claim 4, wherein determining whether the current entrance-behaviour of the at least one person has a requisite correlation with the at least one reference entrance-behaviour comprises determining whether the current entrance-behaviour comprises one or both of:
arriving at or within a predefined proximity to the first milestone location within a first predefined time frame; and/or
arriving at or within a predefined proximity to the second milestone location within a second predefined time frame.

6. The apparatus of claim 1, wherein the at least one reference-entrance-behaviour comprises traversing at least part of the region according to a travel-path and/or through a pathway.

7. The apparatus of claim 1, wherein the at least one reference entrance-behaviour is dependent on one or both of:
contextual conditions, wherein the current entrance-behaviour occurs under said contextual conditions; and/or
a time of entry into the region.

8. The apparatus of claim 1, wherein the triggering event comprises an indication of an object-entry event, wherein the object-entry event may be a specific one or may be any of:
a full or partial disarming of a security system associated with the region;
a detected change in a door state of a door associated with the region;
a detected passage of a person through an entry associated with the region or a physically partitioned portion therein;
a detected passage of a person into the region; and/or
a detected presence or motion at an entry location at which the region can be entered.

9. The apparatus of claim 1, wherein:
the current-entrance-behaviour and/or the reference entrance-behaviour are behaviours of entering the region immediately following a period in which the region is vacant; and
the apparatus is further configured to determine when the region is vacant of humans prior to the entry into the region.

10. The apparatus of claim 1, wherein the at least one RARWD comprises a plurality of RARWDs and the apparatus is a system comprising the plurality of RARWDs, wherein: collecting a first set of RARWD measurements for tracking human position in multiple spatial dimensions within a region observed by the least one RARWD comprises collecting the first set of RARWD measurements for tracking human position in multiple spatial dimensions within a region observed by at least one RARWD of the plurality of RARWDs;
and receiving a second set of RARWD measurements observed by the at least one RARWD comprises receiving the second set of RARWD measurements observed by at least one RARWD of the plurality of RARWDs.

11. The apparatus of claim 1, wherein the apparatus is a device that comprises the at least one RARWD, and the at least one RARWD is one RARWD.

12. A non-transitory computer readable carrier medium having stored thereon instructions configured such that, when executed by at least one processor, configure the at least one processor to monitor a region to detect an intruder using a method comprising:
receiving a first set of Ranging Active Reflective Wave Detector (RARWD) measurements for tracking human position in multiple spatial dimensions within a region observed by at least one RARWD;
obtaining at least one reference entrance-behaviour based on the first set of RARWD measurements, the at least one reference entrance-behaviour defining at least one normal human transit behaviour through at least part of the region following a detected triggering-event associated with entry into the region, the at least one normal human transit behaviour comprising a characteristic defined in multiple spatial dimensions;
after receiving the first set of RARWD measurements, receiving a second set of RARWD measurements to monitor for an intruder into the region;
determining from the second set of RARWD measurements a current entrance-behaviour of at least one person following a detected triggering-event associated with entry into the region, the current entrance-behaviour being determined with respect to multiple spatial dimensions;
determining whether the current entrance-behaviour of the at least one person has a requisite correlation with the at least one reference entrance-behaviour to determine whether a normal entrance-behaviour condition is satisfied; and
responsive to whether the normal entrance-behaviour condition is determined to be satisfied, control output indicative of whether the normal entrance-behaviour condition is determined to be satisfied.

13. The non-transitory computer readable carrier medium of claim 12, wherein: the at least one reference entrance-behaviour is learned based on the first set of RARWD measurements; and the at least one reference entrance-behaviour is learned during a defined learning period, and each of the at least normal human transit behaviours represent any human transit behaviour that is detected as occurring during the defined learning period.

14. The non-transitory computer readable carrier medium of claim 12, wherein the at least one reference entrance-behaviour is defined in relation to one or more instances of a triggering event associated with entry into the region, and each of the at least one normal human transit behaviours represent a human transit behaviour being performed one or more times, each of the one or more times following respective one or more instances of a triggering event associated with entry into the region.

15. The non-transitory computer readable carrier medium of claim 12, wherein each of the at least one reference entrance-behaviours comprises or consists of one or more aspects of behaviour, the one or more aspects of behaviour comprising one or more of:
arriving at a first milestone location associated with a first milestone event;
arriving at second milestone location associated with a second milestone event;
traversing at least part of the region according to a travel-path; and/or
traversing at least part of the region through a pathway.

16. The non-transitory computer readable carrier medium of claim 15, wherein the method comprises analyzing the first set of RARWD measurements to identify the first milestone event and/or the second milestone event based on a detected object performing one or more predefined milestone features of the respective first and/or second milestone event, wherein the milestone features comprise at least one of:
human travel of a predefined distance since being at a defined previous location;
human travel of a predefined displacement from a defined previous location;
a predefined amount of time having passed since a human entered the region or since a triggering event;
changing speed of movement in a predetermined manner by a human after commencing a transit through at least part of the region; and
changing direction of movement in a predetermined manner by a human after commencing a transit through at least part of the region.

17. The non-transitory computer readable carrier medium of claim 12, wherein the at least one reference-entrance-behaviour comprises traversing at least part of the region according to a travel-path and/or through a pathway.

18. The non-transitory computer readable carrier medium of claim 12, wherein the at least one reference entrance-behaviour is dependent on one or both of:
contextual conditions, wherein the current entrance-behaviour occurs under said contextual conditions; and/or
a time of entry into the region.

19. The non-transitory computer readable carrier medium of claim 12, wherein the triggering event comprises an indication of an object-entry event, wherein the object-entry event may be a specific one or may be any of:
a full or partial disarming of a security system associated with the region;
a detected change in a door state of a door associated with the region;
a detected passage of a person through an entry associated with the region or a physically partitioned portion therein;
a detected passage of a person into the region; and/or
a detected presence or motion at an entry location at which the region can be entered.

20. The non-transitory computer readable carrier medium of claim 12, wherein:
the current-entrance-behaviour and/or the reference entrance-behaviour are behaviours of entering the region immediately following a period in which the region is vacant; and
the method further comprises determining when the region is vacant of humans prior to the entry into the region.
